(19) United States
(12) Patent Application Publication
(10) Pub. No.: US 2024/0031759 A1
(43) Pub. Date: Jan. 25, 2024

(54) INFORMATION PROCESSING DEVICE, INFORMATION PROCESSING METHOD, AND INFORMATION PROCESSING SYSTEM

(71) Applicant: SONY GROUP CORPORATION, TOKYO (JP)

(72) Inventor: RYUTARO WATANABE, TOKYO (JP)

(21) Appl. No.: 18/044,426

(22) PCT Filed: Jul. 30, 2021
(86) PCT No.: PCT/JP2021/028303

§ 371 Date: Mar. 8, 2023

(30) Foreign Application Priority Data
Sep. 18, 2020 (JP) 2020-157036

(51) Int. Cl. H04S 7/00

(52) U.S. Cl. CPC H04S 7/303; H04S 7/305; H04S 2420/01

(57) ABSTRACT

Improvement in usability is further promoted. An information processing device (10) includes: an acquisition unit (111) that acquires a positional relationship between a plurality of users arranged in a virtual space; and a generation unit (1122) that generates, on a basis of the positional relationship acquired by the acquisition unit (111), output data of a sound to be presented to a target user from sound data of a sound made by each of the users, wherein the generation unit (1122) generates the output data by using a sound other than a sound that can be directly heard by the target user among the sounds respectively made by the users.

### FIELD

The present disclosure relates to an information processing device, an information processing method, and an information processing system.

### BACKGROUND

In recent years, development of an acoustic technology of causing a sound source that does not actually exist to be perceived as being at an arbitrary position in a real space (actual space) has been advanced. For example, development of an acoustic technology using a technology called a virtual speaker or a virtual surround that provides a virtual acoustic space, or the like has been advanced. By localization of a sound image at an arbitrary position in the real space by the technology of the virtual surround or the like, a user can perceive a virtual sound source.

Furthermore, a remote communication system such as a teleconference system in which communication is performed by mutual communication of videos, voices, and the like of participants (users) in remote locations has been known. For example, a remote communication system that renders a sound, which is collected by a microphone at a remote location, in such a manner that the sound is heard in a different space in a manner similar to the remote location has been known.

### CITATION LIST

### Patent Literature

Patent Literature 1: US 2018/206038 A

### SUMMARY

### Technical Problem

However, in a conventional technology, there is room for promoting further improvement in usability. For example, in the conventional technology, there is a possibility that presence is impaired since a voice of a user in the same space cannot be heard live. Specifically, in the conventional technology, headphones, earphones, or the like are used to hear a voice of a user in the same space/different space via a remote communication system. Thus, it is difficult to hear the voice of the user in the same space live, and there is a possibility that the presence is impaired.

Thus, the present disclosure proposes a new and improved information processing device, information processing method, and terminal device capable of promoting further improvement in usability.

### Solution to Problem

According to the present disclosure, an information processing device is provided that includes: an acquisition unit that acquires a positional relationship between a plurality of users arranged in a virtual space; and a generation unit that generates, on a basis of the positional relationship acquired by the acquisition unit, output data of a sound to be presented to a target user from sound data of a sound made by each of the users, wherein the generation unit generates the output data by using a sound other than a sound that can be directly heard by the target user among the sounds respectively made by the users.

### BRIEF DESCRIPTION OF DRAWINGS

FIG. 1 is a view illustrating a configuration example of an information processing system according to an embodiment.

FIG. 2 is a view illustrating an example of an earphone according to the embodiment.

FIG. 3 is a view illustrating an example of the information processing system according to the embodiment.

FIG. 4 is a view illustrating the configuration example of the information processing system according to the embodiment.

FIG. 5 is a view illustrating the configuration example of the information processing system according to the embodiment.

FIG. 6 is a block diagram illustrating the configuration example of the information processing system according to the embodiment.

FIG. 7 is a view illustrating an example of output data generation processing according to the embodiment.

FIG. 8 is a view illustrating an example of a storage unit according to the embodiment.

FIG. 9 is a flowchart illustrating a flow of processing by an information processing device according to the embodiment.

FIG. 10 is a view illustrating a second example of an information processing system 1 according to the embodiment.

FIG. 11 is a view illustrating an example of output data generation processing according to the embodiment.

FIG. 12 is a flowchart illustrating a flow of processing by the information processing device according to the embodiment.

FIG. 13 is a view illustrating an example of sound reflection according to the embodiment.

FIG. 14 is a view illustrating an example of sound reflection according to the embodiment.

FIG. 15 is a view illustrating an example of spaces with different reflection and reverberation of sound according to the embodiment.

FIG. 16 is a view illustrating a third example of the information processing system 1 according to the embodiment.

FIG. 17 is a view illustrating a fifth example of the information processing system 1 according to the embodiment.

FIG. 18 is a view illustrating a sixth example of the information processing system 1 according to the embodiment.

FIG. 19 is a view illustrating a ninth example of the information processing system 1 according to the embodiment.

FIG. 20 is a view illustrating a tenth example of the information processing system 1 according to the embodiment.

FIG. 21 is a view illustrating an eleventh example of the information processing system 1 according to the embodiment.

FIG. 22 is a view illustrating an example of calibration processing according to the embodiment.

FIG. 23 is a hardware configuration diagram illustrating an example of a computer that realizes functions of the information processing device.

### DESCRIPTION OF EMBODIMENTS

In the following, preferred embodiments of the present disclosure will be described in detail with reference to the accompanying drawings. Note that the same reference signs are assigned to components having substantially the same functional configuration, and overlapped description is omitted in the present specification and the drawings.

Note that the description will be made in the following order.
1. One embodiment of the present disclosure
1.1. Introduction
1.2. Configuration of an information processing system
2. Function of the information processing system
2.1. Outline
2.2. Functional configuration example
2.3. Processing by the information processing system
2.4. Variations of processing
2.4.1. Case where a user moves around (second example)
2.4.2. Cancellation of environmental sound (third example)
2.4.3. Collection of sound with a microphone installed in a
space (fourth example)
2.4.4. Collection of environmental sound (fifth example)
2.4.5. Estimation of a generation position of environmental
sound (sixth example)
2.4.6. Presentation of environmental sound (seventh
example)
2.4.7. Whisper (eighth example)
2.4.8. Presentation of voices of many people (ninth
example)
2.4.9. Sightseeing tour (tenth example)
2.4.10. Teleoperator robot, etc. (eleventh example)
2.4.11. Calibration (twelfth example)
3. Hardware configuration example
4. Conclusion

### 1. One Embodiment of the Present Disclosure

### 1.1. Introduction

In a remote communication system such as a teleconference system according to the conventional technology, since a voice of a user in the same space/different space is heard with headphones, earphones, or the like, there is a case where the voice of the user in the same space cannot be heard live. For example, even in a case where users sit in adjacent seats in the same space, in the remote communication system according to the conventional technology, voice is output from the headphones, the earphones, or the like, there is a case where the users cannot hear the voice live.

The remote communication system according to the conventional technology includes a system that presents a virtual image or sound in a virtual space. For example, there is a system using virtual reality (VR). Generally, in the VR, a user can hear a virtual sound but cannot hear a sound in a real space since the user wears a device such as headphones or earphones. Thus, in the remote communication system using the VR, presence may be impaired since a voice of a user in the same space cannot be heard live. Thus, there is room for promoting further improvement in usability.

Furthermore, in a system using augmented reality (AR), a user can simultaneously hear a virtual sound and a sound in a real space since a virtual image and sound are superimposed and presented in an actual space. However, in a case where users are in the same space, since a sound heard in the real space is also presented as the virtual sound, the users may hear the same sound a plurality of times with a time delay. Thus, there is a possibility that presence is impaired, and there is room for promoting further improvement in usability.

Note that stereophonic sound processing by a virtual sound source will be described as sound AR in the following embodiment. A system using the sound AR includes not only a case of the AR but also a case of the VR.

Thus, the present disclosure proposes a new and improved information processing device, information processing method, and information processing system capable of promoting further improvement in usability.

### 1.2. Configuration of an Information Processing System

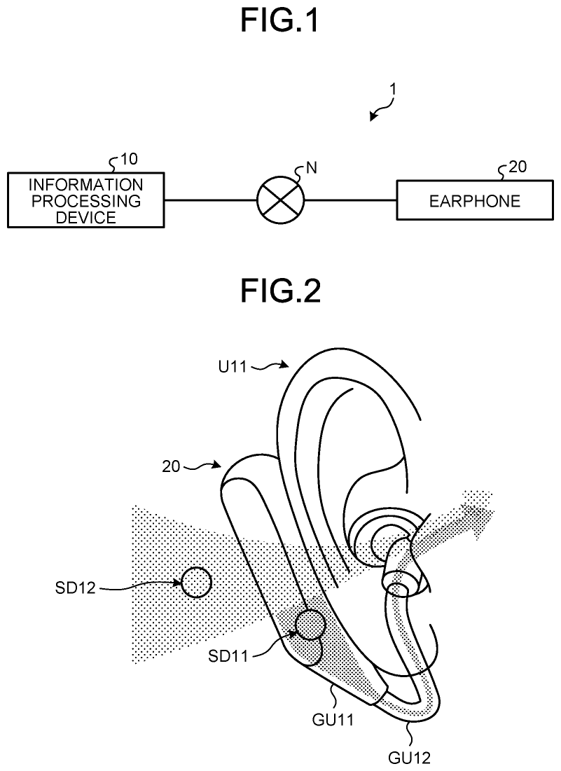

A configuration of an information processing system 1 according to the embodiment will be described. FIG. 1 is a view illustrating a configuration example of the information processing system 1. As illustrated in FIG. 1, the information processing system 1 includes an information processing device 10 and an earphone 20. Various devices may be connected to the information processing device 10. For example, the earphone 20 is connected to the information processing device 10, and cooperation of information is performed between the devices. The information processing device 10 and the earphone 20 are connected to an information communication network N by wireless or wired communication in such a manner as to mutually perform information/data communication and operate in cooperation. The information communication network N may include the Internet, a home network, an Internet of Things (IoT) network, a peer-to-peer (P2P) network, a proximity communication mesh network, or the like. The wireless communication can use, for example, Wi-Fi, Bluetooth (registered trademark), or a technology based on a mobile communication standard such as 4G or 5G. For the wired communication, a power line communication technology such as Ethernet (registered trademark) or power line communications (PLC) can be used.

The information processing device 10 and the earphone 20 may be separately provided as a plurality of computer hardware devices in a so-called on-premises manner, or on an edge server or a cloud, or functions of a plurality of devices of the information processing device 10 and the earphone 20 may be provided as the same device. For example, the information processing device 10 and the earphone 20 may be provided as a device in which the information processing device 10 and the earphone 20 function integrally and communicate with an external information processing device. Furthermore, a user can mutually perform information/data communication with the information processing device 10 and the earphone 20 via a user interface (including a graphical user interface (GUI)) and software (including a computer program (hereinafter, also referred to as a program)) operating on a terminal device (personal device such as a personal computer (PC) or a smartphone including a display as an information display device, and a voice and keyboard input) (not illustrated).

(1) Information Processing Device 10

The information processing device 10 is an information processing device that performs processing of generating output data (such as an output signal or sound data) for reproducing a sound image of a sound generated in a different space that is different from a space (such as a room or inside of a room) of a user to be a target of reproduction (target user) in the space of the target user. Specifically, the information processing device 10 generates the output data to the target user on the basis of positional relationship between a plurality of users arranged in a virtual space. Furthermore, the information processing device 10 generates the output data by using a sound other than a sound that can be directly heard by the target user among sounds respectively made by users. As a result, since the information processing device 10 can present only necessary sound by virtual processing in the remote communication system using the technology of the sound AR, it is possible to promote improvement in presence. Furthermore, the information processing device 10 can promote reduction in processing resources. As a result, the information processing device 10 can promote further improvement in usability.

Furthermore, the information processing device 10 also has a function of controlling overall operation of the information processing system 1. For example, the information processing device 10 controls the overall operation of the information processing system 1 on the basis of information cooperated between the devices. Specifically, the information processing device 10 acquires the positional relationship between the plurality of users arranged in the virtual space on the basis of information transmitted from the earphone 20.

The information processing device 10 is realized by a PC, a server, or the like. Note that the information processing device 10 is not limited to the PC, the server, or the like. For example, the information processing device 10 may be a computer hardware device such as a PC or a server in which a function as the information processing device 10 is mounted as an application.

The information processing device 10 may be any device as long as processing in the embodiment can be realized. Furthermore, the information processing device 10 may be a device such as a smartphone, a tablet terminal, a notebook PC, a desktop PC, a mobile phone, or a PDA. Furthermore, the information processing device 10 may function as a part of another equipment by being incorporated in the other equipment. For example, the information processing device 10 may function as a part of the earphone 20 such as a headphone.

(2) Earphone 20

The earphone 20 is an earphone used by a user to hear a reproduced sound. For example, the earphone 20 performs reproduction on the basis of the output data transmitted from the information processing device 10. Furthermore, the earphone 20 may include a microphone that collects sound such as a voice of the user. Note that in a case where the earphone 20 includes no microphone, the information processing system 1 may use an independent microphone, a microphone provided in AR glasses, or the like, for example. Furthermore, the information processing device 10 may include a microphone that collects sound such as the voice of the user.

The earphone 20 may be anything as long as being a reproduction device of the sound AR. For example, the earphone 20 may be a speaker installed in the AR glasses, a seat speaker installed in a seat, a shoulder speaker for a shoulder, a bone conduction earphone, or the like.

The earphone 20 is a reproduction device with which it is possible to simultaneously hear a reproduced sound (such as music or the like) and an ambient sound (environmental sound). The earphone 20 may be an earphone, a headphone, or the like with which it is possible to hear a sound from the reproduction device simultaneously with the environmental sound. For example, the earphone 20 may be a reproduction device that does not block an ear canal, an open-ear earphone or headphone, a reproduction device having an external sound capturing function, or the like.

FIG. 2 is a view illustrating an example of the earphone 20. As illustrated in FIG. 2, a user U11 can simultaneously hear a reproduced sound SD11 from the earphone 20 and an environmental sound SD12. Note that a member GU11 is a driver unit, and a member 12 is a sound conduit.

### 2. Function of the Information Processing System

The configuration of the information processing system 1 has been described above. Next, functions of the information processing system 1 will be described. Note that it is hereinafter assumed that each user has the earphone 20 in the embodiment.

A head-related transfer function according to the embodiment may be any function as long as being acquired with a transfer characteristic of a sound that reaches an ear of the user from an arbitrary position in a space being an impulse response. For example, the head-related transfer function according to the embodiment may be based on a head related transfer function (HRTF), a binaural room impulse response (BRIR), or the like. Furthermore, the head-related transfer function according to the embodiment may be, for example, measured by a microphone or the like at the ear of the user, acquired by simulation, or estimated by machine learning or the like.

Hereinafter, although a case where the output data generated by the information processing device 10 is received and reproduced by the earphone 20 will be described in the embodiment, this example is not a limitation. For example, the information processing device 10 may present an original sound that is not individually optimized by utilization of the head-related transfer function, and the earphone 20 may perform signal processing according to the embodiment.

Hereinafter, a case where a user in a different space is displayed in a virtual space by utilization of an AR device will be described in the embodiment. However, this example is not a limitation. A display device according to the embodiment may be VR goggles or the like.

### 2.1. Outline

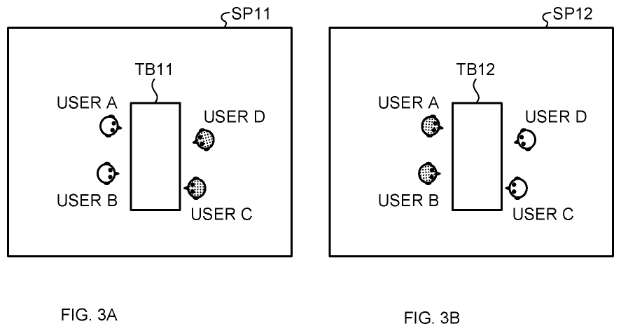

FIG. 3 is a view illustrating an example of the information processing system 1 according to the embodiment. A case where a user A, a user B, a user C, and a user D hold a remote conference is illustrated in FIG. 3. In FIG. 3, the user A and the user B are in a space SP11, and the user C and the user D are in a space SP12. Here, the space SP11 and the space SP12 are different spaces. FIG. 3(A) is a view illustrating a situation in which the user A and the user B are seated in chairs surrounding a table TB11 in the space SP11. Note that the user C and the user D illustrated in FIG. 3(A) are users existing not in a real space but in a virtual space. FIG. 3(B) is a view illustrating a situation in which the user C and the user D are seated in chairs surrounding a table TB12 in the space SP12. Note that the user A and the user B illustrated in FIG. 3(B) are users existing not in a real space but in a virtual space. In this case, the information processing device 10 determines, for each user, a voice of whom is to be presented and at which position the voice is to be presented. Furthermore, the information processing device 10 generates the output data on the basis of only necessary voice on the basis of whether a voice of another user can be directly heard, a mutual positional relationship, and the like. For example, the information processing device 10 may estimate that the user A to the user D are seated in the chairs surrounding the table TB11, and determine positional information of each user from arrangement information of the chairs. In FIG. 3, the positional relationship among the users is in a manner illustrated in FIG. 3.

In FIG. 3, in a case where the user A is a target user, the information processing device 10 generates output data with which a sound of the user C is heard from a position of the user C in the virtual space. Furthermore, the information processing device 10 generates output data with which a sound of the user D is heard from a position of the user D in the virtual space. Furthermore, the information processing device 10 generates output data with which sounds of the user A and the user B are not reproduced. Note that the same applies to a case where the user B is a target user. Then, in a case where the user C is a target user, the information processing device 10 generates output data with which a sound of the user A is heard from a position of the user A in the virtual space. Furthermore, the information processing device 10 generates output data with which a sound of the user B is heard from a position of the user B in the virtual space. Furthermore, the information processing device 10 generates output data with which sounds of the user C and the user D are not reproduced. Note that the same applies to a case where the user D is a target user.

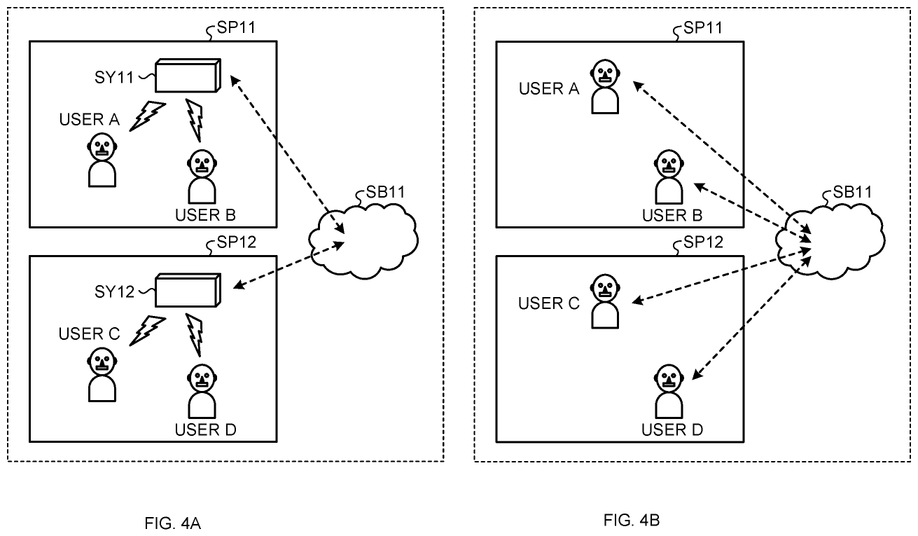

In the information processing device 10, a user terminal such as the earphone 20 held by each of the users may execute the processing by being connected to a server via a repeater (access point) installed in each space, or may execute the processing by being directly connected to the server without the repeater. FIG. 4 is a view illustrating a configuration example of the information processing system 1 according to the embodiment. In FIG. 4(A), the user terminals of the user A and the user B transmit and receive information to and from a server SB11 via a repeater SY11, and the user terminals of the user C and the user D transmit and receive information to and from the server SB11 via a repeater SY12. In FIG. 4(B), the user terminals of the user A to the user D directly transmit and receive information to and from the server SB11. Note that each of the user terminals may be a terminal device such as a smartphone that communicates with the information processing device 10 and the earphone 20.

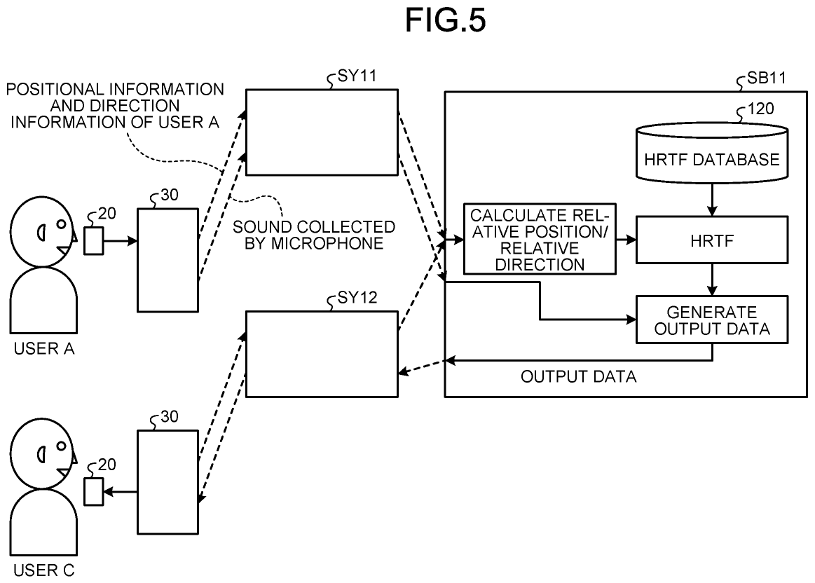

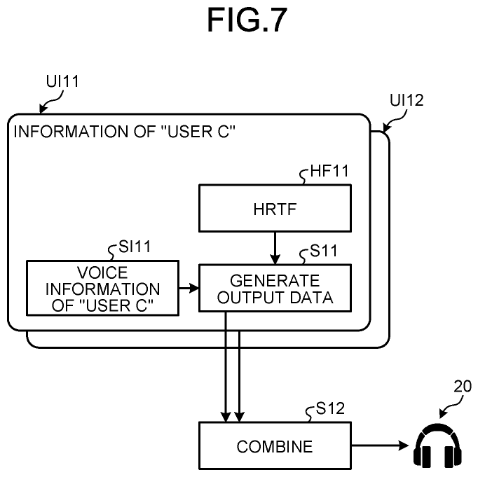

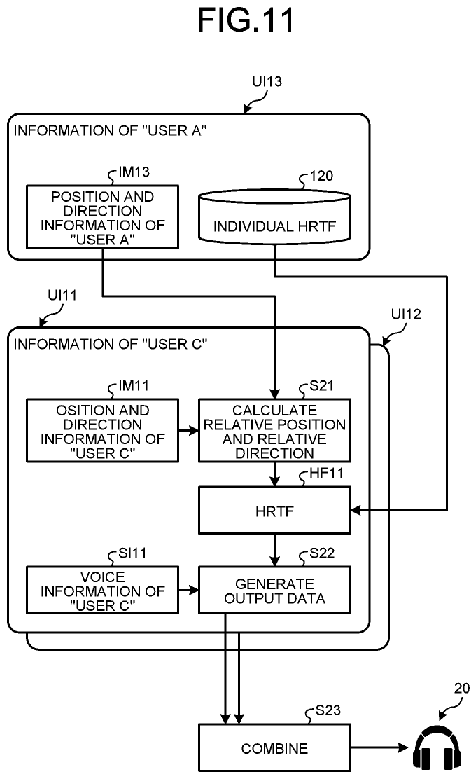

FIG. 5 is a view illustrating the configuration example of the information processing system 1 according to the embodiment. Specifically, FIG. 5 is a view illustrating the configuration example of the information processing system 1 according to the embodiment in a case of FIG. 4(A). In FIG. 5, the information processing system 1 performs, for example, processing for causing the user C to perceive a sound made by the user A. In FIG. 5, the information processing system 1 transmits a signal of a voice of the user A, which voice is collected by the microphone of the earphone 20, to the server SB11 via an user terminal 30 held by the user A and the repeater SY11. Note that details of signal processing in the server SB11 will be described later with reference to FIG. 7, FIG. 11, and the like, whereby a description thereof is omitted. Then, the information processing system 1 transmits output data generated by the server SB11 to the earphone 20 of the user C via the user terminal 30 held by the user C and the repeater SY12. Then, the information processing system 1 performs processing for outputting the output data transmitted to the earphone 20 through a speaker of the earphone 20.

### 2.2. Functional Configuration Example

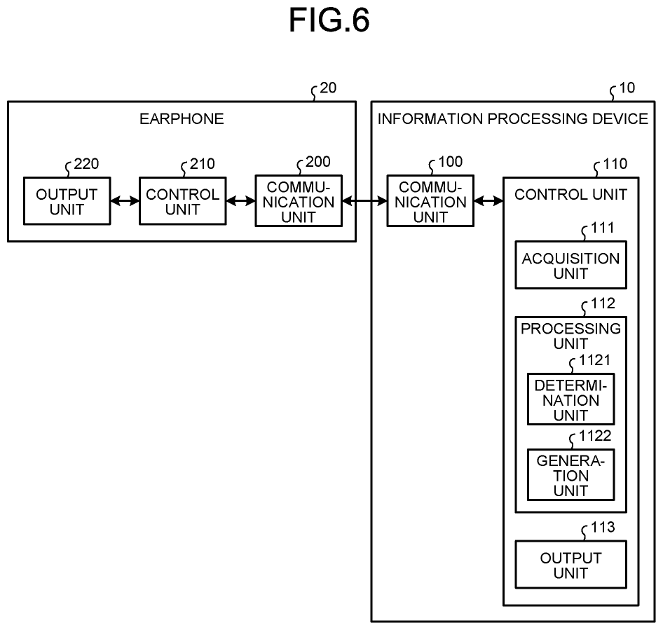

FIG. 6 is a block diagram illustrating a functional configuration example of the information processing system 1 according to the embodiment.

(1) Information Processing Device 10

As illustrated in FIG. 6, the information processing device 10 includes a communication unit 100 and a control unit 110.

(1-1) Communication Unit 100

The communication unit 100 has a function of communicating with an external device. For example, in communication with the external device, the communication unit 100 outputs information received from the external device to the control unit 110. Specifically, the communication unit 100 outputs information received from the earphone 20 to the control unit 110. For example, the communication unit 100 outputs positional information of each user to the control unit 110.

In communication with the external device, the communication unit 100 transmits information input from the control unit 110 to the external device. Specifically, the communication unit 100 transmits, to the earphone 20, control information that is to request transmission of the positional information of each user and that is input from the control unit 110. The communication unit 100 includes a hardware circuit (such as a communication processor), and can be configured to perform processing by a computer program that operates on the hardware circuit or on another processing device that controls the hardware circuit (such as a CPU).

(1-2) Control Unit 110

The control unit 110 has a function of controlling operation of the information processing device 10. For example, the control unit 110 performs processing of generating output data to reproduce a sound image of a sound, which is generated in a different space that is different from a space of a target user, in the space of the target user.

In order to realize the above-described function, the control unit 110 includes an acquisition unit 111, a processing unit 112, and an output unit 113 as illustrated in FIG. 6. The control unit 110 may include a processor such as a CPU, and may read software (computer program) for realizing each of functions of the acquisition unit 111, the processing unit 112, and the output unit 113 from a storage unit 120 and perform processing. Furthermore, one or more of the acquisition unit 111, the processing unit 112, and the output unit 113 can include a hardware circuit (such as a processor) different from the control unit 110, and can be configured to be controlled by a computer program that operates on the different hardware circuit or on the control unit 110.

Acquisition Unit 111

The acquisition unit 111 has a function of acquiring a positional relationship between a plurality of users arranged in a virtual space. For example, the acquisition unit 111 acquires positional information of the users on the basis of GPS information, imaging information, and the like of each of the users. Furthermore, for example, the acquisition unit 111 acquires relative positional information between the users in the virtual space such as an AR space.

The acquisition unit 111 acquires information related to a positional relationship (such as a relative position or relative direction) in the virtual space between one user in a space different from that of a target user (hereinafter, appropriately referred to as a “first user”) and the target user.

As a specific example, the acquisition unit 111 acquires positional information and direction information of each of the users by using sensor information detected by sensors such as a camera (such as an external camera of AR glasses), an acceleration sensor, a gyroscope sensor, and a magnetic compass. Note that these sensors are included in a terminal device such as the AR glasses or a smartphone, for example. Furthermore, the acquisition unit 111 may acquire the positional information and the direction information of each of the users by using, for example, a camera, a distance sensor, and the like installed in a space. Furthermore, the acquisition unit 111 may acquire the positional information and the direction information of each of the users by using, for example a laser, an ultrasonic wave, a radio wave, a beacon, and the like. For example, the acquisition unit 111 may acquire the positional information and the direction information of each of the users by receiving a laser, which is output from an output device installed in a space, with a device that is the earphone 20 or the like and is worn by each of the users.

Furthermore, in a case where the information processing device 10 includes a microphone, the acquisition unit 111 may acquire sound information. For example, the acquisition unit 111 may acquire voice information of the users via the microphone included in the information processing device 10.

Processing Unit 112

The processing unit 112 has a function of controlling processing performed by the information processing device 10. As illustrated in FIG. 6, the processing unit 112 includes a determination unit 1121 and a generation unit 1122. Each of the determination unit 1121 and the generation unit 1122 included in the processing unit 112 may be configured as an independent computer program module, or a plurality of functions may be configured as one collective computer program module.

Determination Unit 1121

The determination unit 1121 has a function of determining whether a user is in the same space as the target user or whether the user is in a different space that is different from that of the target user. For example, the determination unit 1121 determines whether the first user is in the same space as the target user. Note that although a case where it is determined whether the first user is in the same space as the target user will be described below, the determination unit 1121 may determine whether a plurality of users including the target user is in the same space. Furthermore, the determination unit 1121 may specify another user who is in the same space as the target user.

For example, the determination unit 1121 determines whether the first user is in the same space as the target user on the basis of GPS information. Furthermore, for example, the determination unit 1121 determines whether the first user is in the same space as the target user on the basis of an IP address of a used access point. Specifically, in a case where the first user and the target user use the same IP address, the determination unit 1121 determines that the first user is in the same space as the target user.

Furthermore, for example, the determination unit 1121 determines whether the first user is in the same space as the target user on the basis of an entering/leaving record with respect to a specific space. Specifically, in a case where the first user and the target user are included in the entering/leaving record with respect to the specific space, the determination unit 1121 determines that the first user is in the same space as the target user. In such a manner, the determination unit 1121 may specify the user who is in the same space as the target user on the basis of information associated with the space.

Furthermore, for example, the determination unit 1121 determines whether the first user is in the same space as the target user on the basis of sensor information detected by a sensor such as a camera installed in the space. Specifically, in a case where the first user and the target user are included in imaging information captured by the camera or the like installed in the space, the determination unit 1121 determines that the first user is in the same space as the target user. In such a manner, the determination unit 1121 may specify a user who is in the same space as the target user on the assumption that the users included in the imaging information captured by the camera or the like installed in the space are in the same space.

Furthermore, for example, the determination unit 1121 determines whether the first user is in the same space as the target user on the basis of sensor information detected by a sensor such as a camera worn by an arbitrary user. Specifically, in a case where the first user and the target user are included in the imaging information captured by the camera or the like worn by the arbitrary user, the determination unit 1121 determines that the first user is in the same space as the target user. In such a manner, the determination unit 1121 may specify a user who is in the same space as the target user on the assumption that the users included in the imaging information captured by the camera or the like worn by the arbitrary user are in the same space.

Furthermore, for example, the determination unit 1121 determines whether another user is in the same space as the target user on the basis of whether the target user can directly hear a sound existing in the real space. Specifically, on the basis of whether the target user is in a range in which a sound made by another user can be directly heard, the determination unit 1121 determines that the other user is in a different space in a case where the target user is not in the range.

Furthermore, for example, the determination unit 1121 determines whether the first user is in the same space as the target user on the basis of access information to the same game machine. Specifically, in a case where the first user and the target user access the same game machine, the determination unit 1121 determines that the first user and the target user are in the same space. For example, there is a case where a multi-player game in which a plurality of users participates at a time is performed. Furthermore, in a case where a plurality of users participates in the same system via a PC, a television (TV), a set top box, or the like, the determination unit 1121 similarly determines whether the first user is in the same space as the target user. In such a manner, the determination unit 1121 makes the determination on the basis of access information of the plurality of users to the same system.

Furthermore, for example, the determination unit 1121 determines whether the first user is in the same space as the target user on the basis of a communication state between the devices of the users. Specifically, in a case where the device of the target user and the device of the first user can directly communicate with each other via a communication method such as Bluetooth (registered trademark) in which method the devices can communicate with each other directly, the determination unit 1121 determines that the first user is in the same space as the target user.

Generation Unit 1122

The generation unit 1122 has a function of generating, on the basis of the positional relationship acquired by the acquisition unit 111, output data of a sound to be presented to the target user from sound data of a sound made by each user. For example, the generation unit 1122 generates output data to reproduce a sound image of a sound, which is made in a different space that is different from the space of the target user, in the space of the target user. Specifically, the generation unit 1122 generates the output data to the target user on the basis of the head-related transfer function of the target user which function is based on a generation position of the sound in the different space. For example, in order to reproduce a sound source of a sound made by the first user, the generation unit 1122 generates the output data to the target user on the basis of the head-related transfer function of the target user which function is based on the positional relationship between the first user and the target user in the virtual space of when the sound is made.

From a positional relationship between a plurality of users who remotely perform communication, the generation unit 1122 determines a parameter to be used for signal processing to generate the output data (such as a direction and distance of the HRTF, directivity of sound, addition of reflection and reverberation of a space, or the like). Then, the generation unit 1122 generates the output data on the basis of the determined parameter.

FIG. 7 is a view illustrating an example of output data generation processing. Specifically, FIG. 7 is a view illustrating processing of generating output data to the user A in a case where the user A is the target user in FIG. 3. In this case, the acquisition unit 111 acquires user information UI11 of the user C. Specifically, the acquisition unit 111 acquires voice information SI11 of the user C and information related to a head-related transfer function HF11 of the user A which function is based on a positional relationship between the user C and the user A. The generation unit 1122 generates output data of a sound made by the user C on the basis of the voice information SI11 and the head-related transfer function HF11 acquired by the acquisition unit 111 (S11). Similarly, the generation unit 1122 generates output data of a sound made by the user D. Then, the generation unit 1122 generates the output data to the user A by combining the output data of the sound made by the user C and the output data of the sound made by the user D (S12). Note that each head-related transfer function is determined in advance on the basis of a relative position of each of the users which position is determined from the positional relationship of the seats.

As a result, the generation unit 1122 can perform virtual processing of localizing a voice of each user to a position of each user in the virtual space. Furthermore, without presenting a voice of a user which voice can be directly heard among voices of a plurality of users participating in a conference, the generation unit 1122 can generate output data to present a voice of the other user.

Output Unit 113

The output unit 113 has a function of outputting information related to a generation result by the generation unit 1122. The output unit 113 provides the information related to the generation result to the earphone 20 via the communication unit 100, for example. When receiving the information related to the generation result, the earphone 20 outputs a voice of each user in such a manner that the voice of each user is localized at the position of each user in the virtual space.

(1-3) Storage Unit 120

The storage unit 120 is realized by a semiconductor memory element such as a random access memory (RAM) or a flash memory, or a storage device such as a hard disk or an optical disk, for example. The storage unit 120 has a function of storing a computer program and data (including a form of a program) related to processing in the information processing device 10.

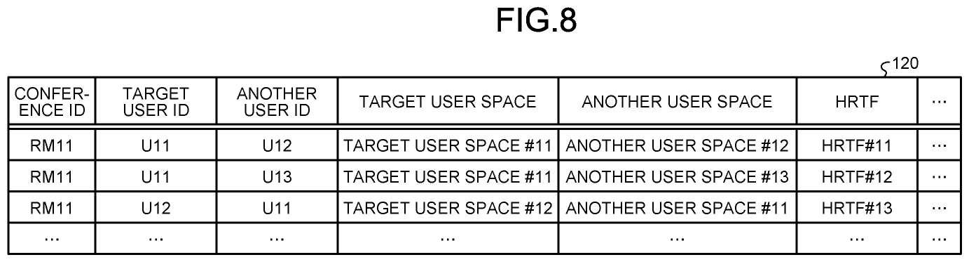

FIG. 8 is a view illustrating an example of the storage unit 120. The storage unit 120 illustrated in FIG. 8 stores information for determining whether a user is in the same space as the target user. As illustrated in FIG. 8, the storage unit 120 may have items such as a “conference ID”, a “target user ID”, an “another user ID”, a “target user space”, an “another user space”, and an “HRTF”.

The “conference ID” indicates identification information for identifying a conference in which a plurality of users who perform communication remotely participates. The “target user ID” indicates identification information for identifying the target user. The “another user ID” indicates identification information for identifying another user other than the target user. The “target user space” indicates information for specifying a space in which the target user is. In the example illustrated in FIG. 8, a case where conceptual information such as a “target user space #11” and a “target user space #12” is stored in the “target user space” is illustrated. However, in practice, data such as GPS information of the target user, information related to an entering/leaving record of the target user with respect to a specific space, or imaging information including the target user is stored. Similarly, the “another user space” indicates information for specifying a space in which the other user is. In the example illustrated in FIG. 8, a case where conceptual information such as an “another user space #11” or an “another user space #12” is stored in the “another user space” is illustrated. However, in practice, data such as GPS information of the other user, information related to an entering/leaving record of the other user with respect to a specific space, or imaging information including the other user is stored. The “HRTF” indicates an HRTF of the target user which HRTF is determined in advance on the basis of positional information of the target user and positional information of the other user. In the example illustrated in FIG. 8, a case where conceptual information such as an “HRTF #11” and an “HRTF #12” is stored in the “HRTF” is illustrated. However, in practice, HRTF data that is an impulse response of a transmission characteristic of a sound that reaches an ear of the target user is stored.

(2) Earphone 20

As illustrated in FIG. 6, the earphone 20 includes a communication unit 200, a control unit 210, and an output unit 220.

(2-1) Communication Unit 200

The communication unit 200 has a function of communicating with an external device. For example, in communication with the external device, the communication unit 200 outputs information received from the external device to the control unit 210. Specifically, the communication unit 200 outputs information received from the information processing device 10 to the control unit 210. For example, the communication unit 200 outputs information related to acquisition of output data to the control unit 210.

(2-2) Control Unit 210

The control unit 210 has a function of controlling operation of the earphone 20. For example, the control unit 210 performs processing for outputting output data on the basis of information, which is transmitted from the information processing device 10, via the communication unit 200. Specifically, the control unit 210 converts a signal received from the information processing device 10 into a voice signal and provides voice signal information to the output unit 220.

(2-3) Output Unit 220

The output unit 220 is realized by a member capable of outputting sound, such as a speaker. The output unit 220 outputs output data.

### 2.3. Processing by the Information Processing System

In the above, the function of the information processing system 1 according to the embodiment has been described. Next, processing by the information processing system 1 will be described.

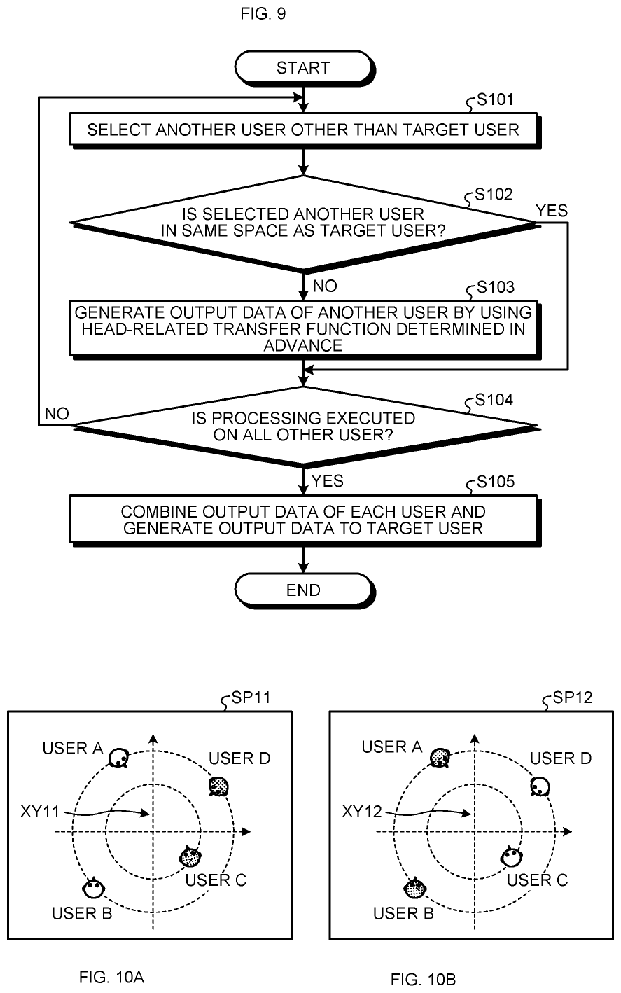

FIG. 9 is a flowchart illustrating a flow of processing by the information processing device 10 according to the embodiment. Specifically, FIG. 9 is a view illustrating processing of generating output data to the target user. The information processing device 10 selects another user other than the target user from among a plurality of users who perform communication remotely (S101). Note that the selection of another user may be performed on the basis of any algorithm, and the selection may be randomly performed or may be performed in a predetermined order determined in advance, for example. Then, the information processing device 10 determines whether the selected other user is in the same space as the target user (S102). In a case where the information processing device 10 determines that the selected other user is not in the same space as the target user (S102; NO), output data of the other user is generated by utilization of a predetermined head-related transfer function (S103). Then, the information processing device 10 determines whether the above processing is executed on all of other users other than the target user (S104). Furthermore, in a case where the information processing device 10 determines in Step S102 that the selected other user is in the same space as the target user (S102; YES), processing of Step S104 is performed without the processing of Step S103. In a case where the information processing device 10 determines that the above processing is executed on all the other users other than the target user (S104; YES), pieces of output data of the users are combined and the output data to the target user is generated (S105). Furthermore, in a case where the information processing device 10 determines that the above processing is not yet executed on all the other users other than the target user (S104; NO), the processing returns to Step S101.

### 2.4. Variations of Processing

The embodiment of the present disclosure has been described above. Next, variations of processing of the embodiment of the present disclosure will be described. Note that variations of the processing described below may be independently applied to the embodiment of the present disclosure, or may be applied to the embodiment of the present disclosure in combination. Furthermore, the variations of the processing may be applied instead of the configuration described in the embodiment of the present disclosure, or may be additionally applied to the configuration described in the embodiment of the present disclosure.

### 2.4.1. Case where a User Moves Around (Second Example)

In the above embodiment, a case where the information processing device 10 determines positional information of each user on the basis of arrangement information of a chair on the assumption that each user is seated in the chair has been described. Here, a case where each user freely moves around in each space will be described. Note that an example of a case where each user freely moves around will be hereinafter appropriately referred to as a “second example”.

FIG. 10 is a view illustrating a second example of the information processing system 1 according to the embodiment. Note that a description similar to that of FIG. 3 will be omitted as appropriate. In the second example, a coordinate system is determined in each of a space SP11 and a space SP12. FIG. 10(A) is a view illustrating a situation in which a user A and a user B freely move around in the space SP11. Then, positional information of the user A and the user B is determined in a coordinate system XY11 determined in advance in the space SP11. FIG. 10(B) is a view illustrating a situation in which a user C and a user D freely move around in the space SP12. Then, positional information of the user C and the user D is determined in a coordinate system XY12 determined in advance in the space SP12. Note that in FIG. 10, although each user is illustrated as staying at a position illustrated in FIG. 10, it is assumed that each user actually moves around freely. In this case, the information processing device 10 generates output data on the basis only of a necessary voice based on direction information or the like of each user in addition to whether a voice of another user can be directly heard and a mutual positional relationship.

FIG. 11 is a view illustrating an example of output data generation processing. Specifically, FIG. 11 is a view illustrating processing of generating output data to the user A in a case where the user A is the target user in FIG. 10. In this case, the acquisition unit 111 acquires user information UI13 of the user A. Specifically, the acquisition unit 111 acquires positional information and direction information (position/direction information IM13) of the user A.

Furthermore, the acquisition unit 111 acquires user information UI11 of the user C. Specifically, the acquisition unit 111 acquires positional information and direction information (position/direction information IM11) of the user C. The generation unit 1122 calculates relative positional information and relative direction information of the user A and the user C on the basis of the position/direction information IM11 and the position/direction information IM13 (S21). Then, the acquisition unit 111 acquires information related to a corresponding head-related transfer function HF11 of the user A from the storage unit 120 on the basis of the calculated relative positional information and relative direction information. Then, the generation unit 1122 generates output data of a sound made by the user C on the basis of voice information SI11 and the head-related transfer function HF11 acquired by the acquisition unit 111 (S22). Similarly, the generation unit 1122 generates output data of a sound made by the user D. Then, the generation unit 1122 generates the output data to the user A by combining the output data of the sound made by the user C and the output data of the sound made by the user D (S23).

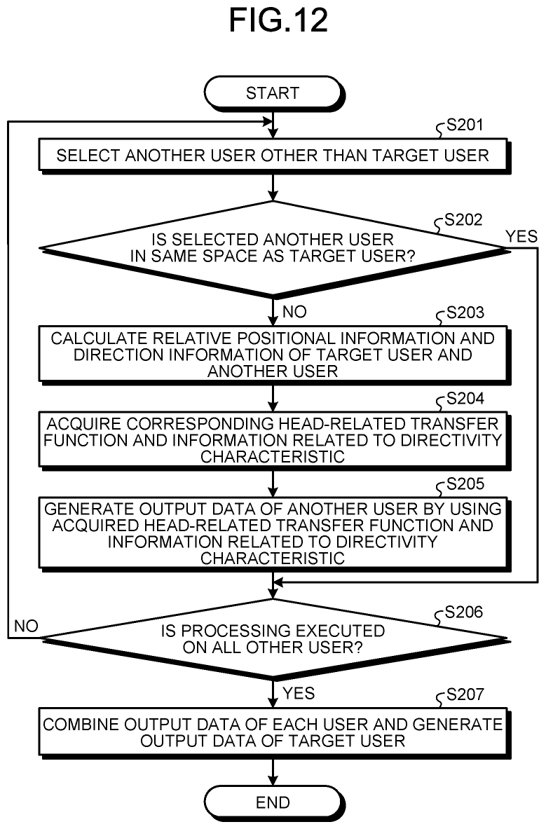

FIG. 12 is a flowchart illustrating a flow of processing by the information processing device 10 according to the embodiment. Specifically, FIG. 12 is a view illustrating processing of generating output data to the target user. The information processing device 10 selects another user other than the target user from among a plurality of users who perform communication remotely (S201). Then, the information processing device 10 determines whether the selected other user is in the same space as the target user (S202). In a case where the information processing device 10 determines that the selected other user is not in the same space as the target user (S202; NO), relative positional information and relative direction information between the target user and the other user are calculated (S203). Then, the information processing device 10 acquires a corresponding head-related transfer function and information related to a directivity characteristic on the basis of the calculated information (S204). Then, the information processing device 10 generates output data of the other user by using the head-related transfer function and the information related to the directivity characteristic (S205). Subsequently, the information processing device 10 determines whether the above processing is executed on all the other users other than the target user (S206). Furthermore, in a case where the information processing device 10 determines in Step S202 that the selected other user is in the same space as the target user (S202; YES), the processing of Step S206 is performed without the processing of Step S203 to Step S205. In a case where the information processing device 10 determines that the above processing is executed on all the other users other than the target user (S206; YES), pieces of output data of the users are combined and the output data to the target user is generated (S207). Furthermore, in a case where the information processing device 10 determines that the above processing is not yet executed on all the other users other than the target user (S206; NO), the processing returns to Step S201.

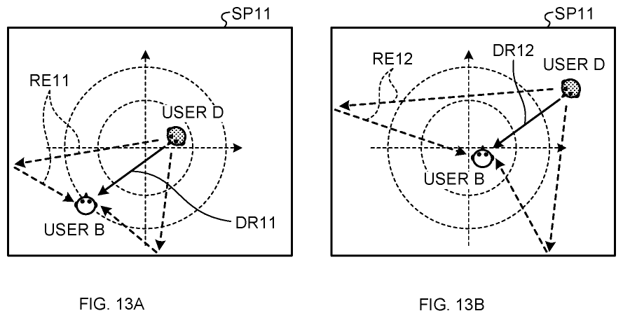

In the second example, even when the relative positions of the target user and the other user are the same, reflected sound heard by the target user may vary depending on positions and directions of the spaces of each other. FIG. 13 is a view illustrating an example of sound reflection according to the embodiment of a case where a user B hears a sound made by a user D. In FIG. 13, a solid line represents a direct sound, and a broken line represents a reflected sound. In FIG. 13(A) and FIG. 13(B), it is assumed that relative positions and relative directions of the user B and the user D are the same. Here, since the relative positions of the user B and the user D are the same, a direct sound DR11 and a direct sound DR12 may be the same. However, since time required for a reflected sound RE11 to reach the user B is different from time required for a reflected sound RE12 to reach the user B, a reflected sound RE11 and the reflected sound RE12 may be different from each other. The generation unit 1122 generates output data in which reflection and reverberation of a sound generated in a space different from that of the target user until the sound reaches the target user in the virtual space are added. Specifically, the generation unit 1122 generates the output data to the target user on the basis of the head-related transfer function of the target user, which function includes reflection and reverberation of the sound made by the other user until the sound reaches the target user in the virtual space, on the basis of positional information of the target user in the virtual space and positional information of the other user in the virtual space.

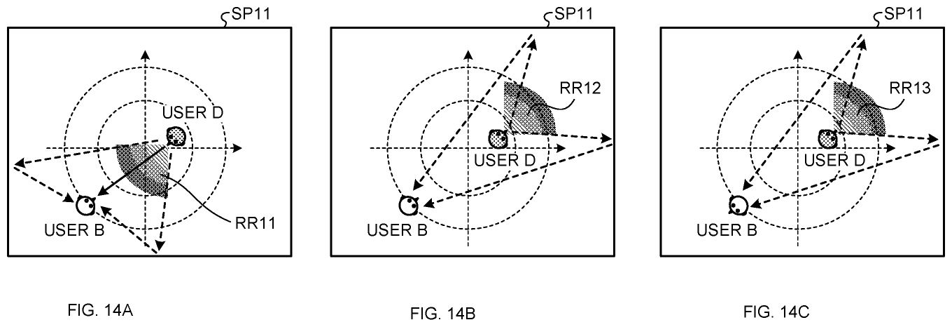

Similarly to FIG. 13, FIG. 14 is a view illustrating an example of sound reflection according to the embodiment of a case where a user B hears a sound made by a user D. In FIG. 14(A) to FIG. 14(C), it is assumed that the relative positions of the user B and the user D are the same. Furthermore, it is assumed that relative directions of the user B and the user D are different in FIG. 14(A) to FIG. 14(C). Note that a description similar to that of FIG. 13 will be omitted as appropriate. FIG. 14(A) is a view illustrating a case similar to that of FIG. 13(A). A direction range RR11 indicates a range of a spread of a sound made by the user D (the same applies to a direction range RR12 and the direction range RR12 described later). Note that the direction range RR11 to a direction range RR13 are ranges for convenience and are not limited to ranges of the illustrated size. Since the user B is in a direction of the direction range RR11, there is a direct sound to the user B. Unlike FIG. 14(A), FIG. 14(B) and FIG. 14(C) are views illustrating a case where the user D makes a sound in a direction opposite to the user B in the virtual space. Since the user B does not exist in the directions of the direction range RR12 and the direction range RR13, there is no direct sound to the user B. Furthermore, in FIG. 14(B) and FIG. 14(C), since relative directions of the user B and the user D are different, reflection sounds and reverberation sounds reaching the user B may also be different. The generation unit 1122 generates output data, to which reflection and reverberation of a sound made by another user until the sound reaches the target user in the virtual space are added, on the basis of relative direction information between the target user and the other user in the virtual space.

The generation unit 1122 may generate output data in which reflection and reverberation of a sound made by the first user are made to match with the space in which the target user is. In a case where the target user is in a space with relatively large reflection and reverberation, such as a bathroom and the first user is in a space with relatively small reflection and reverberation, such as a movie theater, a feeling of strangeness may be generated when a dry sound is heard in the space with the large reflection and reverberation.

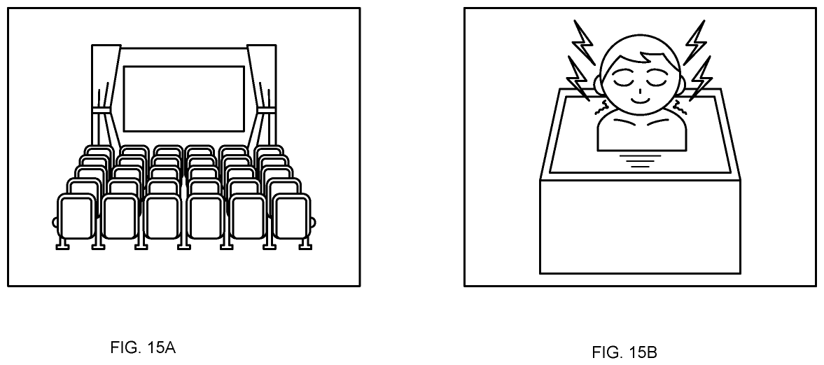

FIG. 15 is a view illustrating an example of spaces with different reflection and reverberation of sound. FIG. 15(A) is a view illustrating a movie theater as an example of a space with small reflection and reverberation. FIG. 15(B) is a view illustrating a bathroom as an example of a space with large reflection and reverberation. The generation unit 1122 may generate output data to the target user on the basis of attribute information of the space of the first user and attribute information of the space of the target user. Specifically, the generation unit 1122 may generate the output data to the target user by using a degree of reflection and reverberation of sound, which degree is estimated on the basis of the attribute information of the space of the target user, for reflection and reverberation of a sound made by the first user. For example, in a case where a difference between the degree of reflection and reverberation of sound which degree is estimated on the basis of the attribute information of the space of the target user and a degree of reflection and reverberation of sound which degree is estimated on the basis of attribute information of a different space is equal to or larger than a predetermined threshold, the generation unit 1122 may generate the output data to the target user by using the degree of reflection and reverberation of sound, which degree is estimated on the basis of the attribute information of the space of the target user, for reflection and reverberation of sound in a virtual space.

### 2.4.2. Cancellation of Environmental Sound (Third Example)

In the above embodiment, a case where the information processing device 10 performs processing for presenting all sounds generated in a different space to the target user has been described. Here, processing for preventing an environmental sound such as a noise generated in a different space from being presented to a target user will be described. Note that an example of a case where an environmental sound generated in a different space is prevented from being presented to the target user will be hereinafter referred to as a “third example” as appropriate.

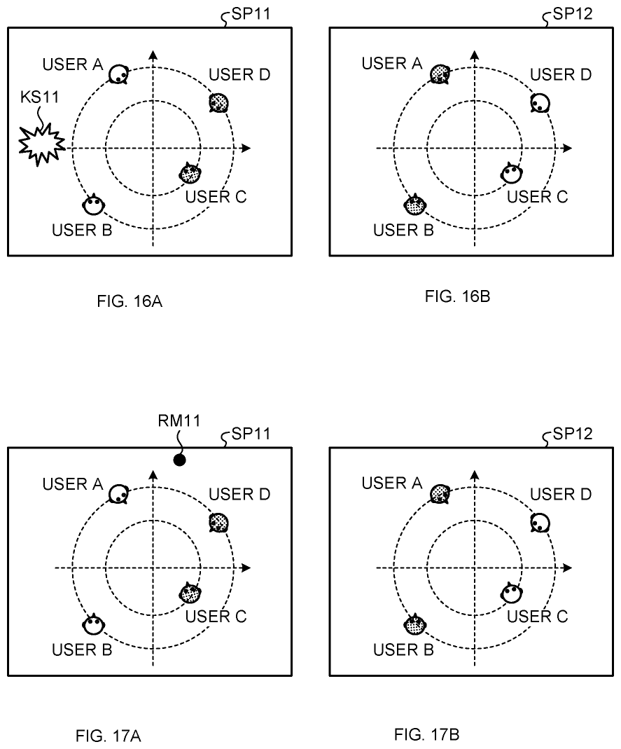

FIG. 16 is a view illustrating a third example of the information processing system 1 according to the embodiment. Note that a description similar to that of FIG. 3 will be omitted as appropriate. In FIG. 16, an environmental sound KS11 is generated in a space where a user A and a user B exist. Here, the environmental sound KS11 is, for example, a noise generated when an object falls, or the like. For example, there is a case where collection of the environmental sound KS11 by a microphone worn by the user B and presentation thereof to a user C and a user D as a sound existing at a position of the user B are not intended operation by the user B. In such a case, the information processing device 10 presents, to the user C and the user D, only a sound made by the user B among sounds collected by the microphone of the user B, for example.

The generation unit 1122 extracts only utterance by utterance section detection or sound discrimination. Furthermore, the generation unit 1122 extracts only utterance of the user B from the detected utterance section by, for example, a speaker identification or speaker separation technology. Note that in a case where there is only one user B in the space, the generation unit 1122 extracts utterance in the detected utterance section as the utterance of the user B. In such a manner, in order to reproduce, in a virtual space, only a sound image of a sound intended by a user in a different space, the generation unit 1122 generates output data for reproducing only a sound image of a sound in an utterance section of the first user identified by the speaker identification among utterance sections detected by the utterance section detection. As a result, the generation unit 1122 can generate the output data for reproducing, in the virtual space, only the sound image of the sound intentionally made by the first user as a sound existing at a position of the first user.

In order to reproduce only a sound image of a sound intended by a user in a different space in a virtual space, in addition to the utterance section detection or the sound discrimination as described above, the generation unit 1122 may generate the output data for reproducing only the sound image of the sound of the first user by collecting only the sound of the first user by using beam forming processing by a directional microphone or an array microphone. In addition, the generation unit 1122 may generate output data acquired by cancellation of a sound, which is made by a second user who is in the same space as the first user, among sounds collected by a microphone of the first user in the different space by using an echo canceller or the like.

### 2.4.3. Collection of Sound with a Microphone Installed in a Space (Fourth Example)

In the third example, a case where the information processing device 10 performs the processing for presenting a sound collected by a microphone of each user to the target user has been described. Here, processing of a case where a sound of each user is collected by utilization of a microphone installed in a space (hereinafter, appropriately referred to as a “room microphone”) will be described. Note that an example of a case where a sound collected by a room microphone is presented to a target user is hereinafter referred to as a “fourth example” as appropriate.

A view illustrating the fourth example of the information processing system 1 according to the embodiment is similar to FIG. 16 (third example). Note that a description similar to that of FIG. 16 will be omitted as appropriate. In this case, for example, the information processing device 10 specifies positional information of each user with positional information of the room microphone as a reference and presents, to a target user, only a sound made by the first user who is a target.

The generation unit 1122 presents only a sound made by each user to the target user by using beam forming processing targeting a position of each user. Specifically, on the basis of positional information of a room microphone in a space of a different space and positional information of the first user in the space of the different space, the generation unit 1122 generates the output data by extracting only the sound made by the first user by using the beam forming processing targeting a position of the first user from the room microphone.

### 2.4.4. Collection of Environmental Sound (Fifth Example)

In the fourth example, a case where the information processing device 10 performs the processing for presenting, to the target user, only the sound made by the first user who is the target has been described. Here, processing of a case where an environmental sound is collected by utilization of a room microphone or the like will be described. Note that an example of a case where an environmental sound collected by a room microphone or the like is presented to a target user is hereinafter referred to as a “fifth example” as appropriate. Furthermore, although a case where an environmental sound is collected by a room microphone is described in the fifth example, a microphone to collect the environmental sound is not limited to the room microphone. For example, a microphone according to the fifth example may be a microphone worn by each user to collect the environmental sound.

FIG. 17 is a view illustrating the fifth example of the information processing system 1 according to the embodiment. Note that a description similar to that of FIG. 16 will be omitted as appropriate. In FIG. 17, a room microphone RM11 is installed at a predetermined position in a space of a space SP11 where a user A and a user B exist. In the third example, a case where voices made by the user A and the user B are collected by the room microphone has been described. However, since the voices of the user A and the user B may be collected by dedicated microphones respectively held thereby, presentation of sounds, which are made by the user A and the user B and collected by the room microphone, to the user C and the user D may not be the intended operation of the user A and the user B. In such a case, the information processing device 10 presents, to the user C and the user D, a sound other than the voices of the user A and the user B among the sounds collected by the room microphone RM11, for example. As a result, the information processing device 10 can promote improvement in presence as if the user C and the user D are present in the same space as the user A and the user B by presenting the environmental sound (such as noise, din from the outside, and the like) by using the room microphone or the like.

In order to reproduce, in a virtual space, a sound image of an environmental sound generated in a different space, the generation unit 1122 generates output data by extracting only the environmental sound other than a sound of the first user and the like (such as a user A and a user B) which sound is specified by voice recognition. In addition, the generation unit 1122 may generate output data acquired by cancellation, by utilization of an echo canceller or the like, of the sound made by the first user and the like among sounds collected by a room icon or the like installed in the different space. In such a manner, the generation unit 1122 generates the output data to reproduce a sound image of the environmental sound other than the sound made by each user in the different space.

In the fifth example, the information processing device 10 may perform processing for localizing the environmental sound collected by the room microphone or the like, for example, to a position of the room microphone or the like or may not perform processing for localizing the environmental sound to a specific position.

### 2.4.5. Estimation of a Generation Position of Environmental Sound (Sixth Example)

In the fifth example, a case where the information processing device 10 performs the processing for presenting the environmental sound collected by the room microphone or the like to the target user regardless of a generation position of the environmental sound has been described. Here, processing of a case where a generation position of the environmental sound is estimated and a sound image is localized at the estimated position will be described. Note that an example of a case where an environmental sound is estimated and a sound image is localized will be hereinafter referred to as a “sixth example” as appropriate.

FIG. 18 is a view illustrating the sixth example of the information processing system 1 according to the embodiment. Note that a description similar to that of FIG. 17 will be omitted as appropriate. In FIG. 18, a room microphone RM11 is installed at a predetermined position in a space of a space SP11 where a user A and a user B exist. In addition, an environmental sound KS11 is generated in the space of the space SP11 in FIG. 18. In such a case, the information processing device 10 estimates a generation position of a sound source of the environmental sound by, for example, beam forming processing or the like using information collected by a plurality of microphones. At this time, it is assumed that the information processing device 10 may perform processing by appropriately combining a dedicated microphone held by each user and the room microphone. Furthermore, the information processing device 10 may use, for example, an array microphone or the like as the dedicated microphone held by each user or the room microphone.

In the sixth example, the processing unit 112 may include an estimation unit 1123 in addition to the determination unit 1121 and the generation unit 1122. Each of the determination unit 1121, the generation unit 1122, and the estimation unit 1123 included in the processing unit 112 may be configured as an independent computer program module, or a plurality of functions may be configured as one collective computer program module.

The estimation unit 1123 has a function of estimating a generation position of a sound generated in a different space. For example, the estimation unit 1123 estimates a generation position of an environmental sound by performing beam forming processing by appropriately combining the dedicated microphone held by each user and the room microphone.

The generation unit 1122 generates output data to reproduce a sound image of the sound, which is generated in the different space, in a virtual space on the basis of the generation position estimated by the estimation unit 1123.

### 2.4.6. Presentation of Environmental Sound (Seventh Example)

In the sixth example, a case where the information processing device 10 estimates the generation position of the environmental sound in the different space and performs the processing for localizing the sound image at the position in the virtual space which position corresponds to the estimated generation position has been described. However, there is a case where an environmental sound does not have a clear localization. In this case, for example, localizing an environmental sound having no clear localization among sounds collected by a room microphone or the like at a position of the room microphone or the like may give an unnatural impression to a target user. Here, processing of a case where the environmental sound having no clear localization is presented to the target user without being localized at a clear position will be described. Note that an example of a case where the environmental sound having no clear localization is presented to the target user without being localized at a clear position is hereinafter referred to as a “seventh example” as appropriate.

A view illustrating the seventh example of the information processing system 1 according to the embodiment is similar to FIG. 17 (fifth example). Note that a description similar to that of FIG. 17 will be omitted as appropriate. There is a case where a din due to public transportation or the like is naturally heard from a window side of a space, for example. In this case, the information processing device 10 analyzes what kind of sound is included in a sound collected by a room microphone or the like, and performs processing for determining, in a virtual space, a virtual sound source heard from a natural position for a target user. For example, the information processing device 10 may perform sound image localization processing in such a manner that sound is heard from a right side in the virtual space in a case where a window side of a space SP12 is the right side even in a case where sound from a left side which is a window side of a space SP11 is collected.

Furthermore, by using an Ambisonics microphone, an array microphone, or the like as the room microphone or the like, the information processing device 10 may perform processing for reproducing the collected sound in a coordinate system centered on the target user instead of reproducing the collected sound in a coordinate system centered on the microphone. As a result, the information processing device 10 can cause the target user to more appropriately perceive an ambient sound.

Furthermore, in a case where a sound uncomfortable for the target user (such as an operation noise of construction or the like) or an unnecessary sound (such as public announcement or the like) is included in the sound collected by the room microphone or the like, the information processing device 10 may perform processing for not presenting such a sound to the target user.

In the seventh example, the generation unit 1122 generates output data to reproduce a sound image of the environmental sound at a predetermined position in the virtual space which position is estimated on the basis of attribute information of an environmental sound generated in a different space and attribute information of a space of the target user.

### 2.4.7. Whisper (Eighth Example)

In the above embodiment, a case where the information processing device 10 performs the processing for presenting the sound made by the first user to all users in a space different from the first user has been described. Here, processing of a case where a sound made by the first user is presented only to a specific user will be described. For example, there is a conversation performed between only a part of users (such as a whisper). Note that an example of a case where the sound made by the first user is presented only to a specific user is hereinafter referred to as an “eighth example” as appropriate. Note that the specific user according to the eighth example may be a user who is in the same space as the first user or a user who is in a different space. Furthermore, the specific user according to the eighth example is not limited to a single user, and may indicate a plurality of users.

A view illustrating the eighth example of the information processing system 1 according to the embodiment is similar to FIG. 10 (second example). Note that a description similar to that of FIG. 10 will be omitted as appropriate. In this case, for example, the information processing device 10 may perform processing for presenting the sound made by a user A only to a user C at whom the user A glances when the user A makes the sound with a small voice. At this time, the information processing device 10 may perform sound image localization processing as if the user A utters, for example, near or at the ear of the user C. As a result, the information processing device 10 can cause the user C to perceive as if the user A utters, for example, near or at the ear of the user C.

Furthermore, there is a case where a user B who is in the same space as the user A can also hear the sound made by the user A to the user C with a small voice, for example. In this case, the information processing device 10 may perform processing for reproducing, by a reproduction device of the user B, a signal for canceling the sound made by the user A. As a result, the information processing device 10 can prevent the user B from hearing the sound emitted by the user A with the small voice.

In the eighth example, in a case where the first user makes a sound with a volume (sound pressure level) equal to or smaller than a predetermined threshold, the generation unit 1122 generates output data to a target user with a user specified on the basis of eye gaze information of the first user as the target user. Note that the generation unit 1122 may generate, as the eye gaze information, output data to a target user with a user specified on the basis of a direction of a head of the first user as the target user. Furthermore, the generation unit 1122 generates output data to a second user, which data is to cancel the sound made by the first user, in such a manner that the second user who is in the same space as the first user does not hear the sound made by the first user.

### 2.4.8. Presenting Voices of Many People (Ninth Example)

In the above embodiment, a case where the information processing device 10 performs the processing for localizing the sound image of the sound made by each user at the position corresponding to each user in the virtual space has been described. However, in a case where each user who is an audience wears a microphone in a case of watching a sport in a stadium or the like, there is a case where it is not necessary to localize a sound of each user at a clear position. Here, processing of a case where it is not necessary to individually generate output data for a sound made by each user will be described. Note that an example of a case where it is not necessary to individually generate output data for the sound made by each user will be hereinafter referred to as a “ninth example” as appropriate. In addition, although the ninth example will be described in the following with sport watching in a stadium as an example, the ninth example is not limited to the sport watching in a stadium. For example, the example may include an appreciation in a theater or a live venue.

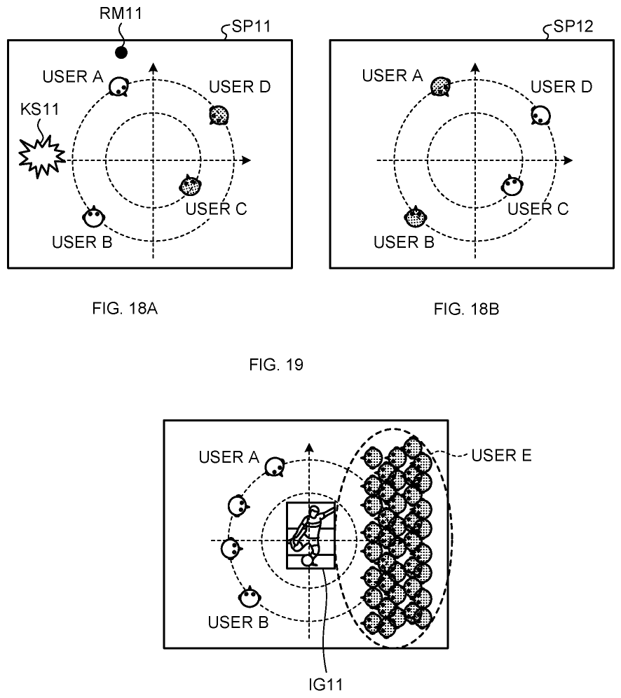

FIG. 19 is a view illustrating the ninth example of the information processing system 1 according to the embodiment. FIG. 19 is a bird's eye view of the stadium from above. Furthermore, in FIG. 19, users included in a range in a certain direction in a virtual space as viewed from a user A are collectively referred to as users E. Here, the users E are users who are in a different space from the user A. For example, the users E are users who are actually watching a sport in the stadium. Note that an image IG11 is a view for convenience of indicating that the users E and the like are watching a sport, and is not an image actually displayed on AR glasses or the like. The users E are, for example, users who are on the opposite side of the stadium in the virtual space as viewed from the user A and support a different team from the user A. In this case, the information processing device 10 performs processing for localizing a sound image in a certain direction as viewed from the user A by using sounds made by users included in a range in the certain direction as viewed from the user A as a sound of one large sound source made by the users E. As a result, the information processing device 10 can promote reduction in a processing amount by processing the sound made by the users included in the range in the certain direction as viewed from the user A as the sound of the one large sound source made by the users E.

In addition to a case where a sound made by each user is collected by a microphone of each user, the information processing device 10 may perform processing by collecting a sound made by each user by using a microphone installed in the stadium or the like.

Furthermore, the information processing device 10 may perform processing for making it easier for the target user to hear a sound that the target user desires to hear. For example, the information processing device 10 may perform processing for making it easier for the target user to hear the sound that the target user desires to hear, such as increasing a sound related to a game such as play and decreasing a sound of the audience as compared with a case where the target user is actually in the stadium or the like. For example, the information processing device 10 may perform processing for making it easier for the target user to hear the sound, which the target user desires to hear, by adjusting volume, sound quality, and the like.

Here, a user B may be a user who is in the same space as the user A, or may be a user who is in a different space that is different from that of the user A. In FIG. 19, the user B is a user who is in the same space as the user A. The user B is, for example, a user who is on the same side of the stadium in the virtual space as viewed from the user A, and is a user who supports the same team as the user A.

For example, in a case where the user B who is in the same space as the user A talks to the user A, the information processing device 10 may perform processing of reducing the volume of the sound such as a cheer by the users E which sound is presented to the user A by the virtual processing. Alternatively, in order to facilitate the conversation between the user A and the user B, the information processing device 10 may perform processing of reducing the volume of the sound such as the cheer by the user E, which sound is presented by the virtual processing, on both the user A and the user B.

Furthermore, for example, in a case where volume of another user such as the user B who is in the same space as the user A is equal to or larger than a predetermined threshold, the information processing device 10 may perform processing for reducing the volume of the other user by using an echo canceller or the like. For example, there is a case where the user A concentrates on watching a game in a sports bar or the like. In this case, the information processing device 10 may perform processing for reducing not only the virtual volume of the other user in the virtual space but also the volume of the other user in a real space.

In the ninth example, in a case where the number of users in the different space is equal to or larger than a predetermined threshold, the generation unit 1122 uses a plurality of sounds made by the users of the number as one sound source, and generates output data to reproduce a sound image of the sound source at a predetermined position in the virtual space.

### 2.4.9. Sightseeing Tour (Tenth Example)

In the above embodiment, a case where the information processing device 10 performs processing for presenting the environmental sound generated in the space SP11 to the user in the space SP12 and presenting the environmental sound generated in the space SP12 to the user in the space SP11 has been described. Here, processing of a case where the space SP11 is a space having predetermined attribute information will be described. Note that an example of a case where a space of one user among a plurality of users who perform communication remotely has predetermined attribute information will be hereinafter referred to as a “tenth example” as appropriate. In addition, hereinafter, as an example of the space having the predetermined attribute information, a case where a space SP11 is a tourist spot will be described as an example. However, this example is not a limitation. Note that the predetermined attribute information may be determined in advance.

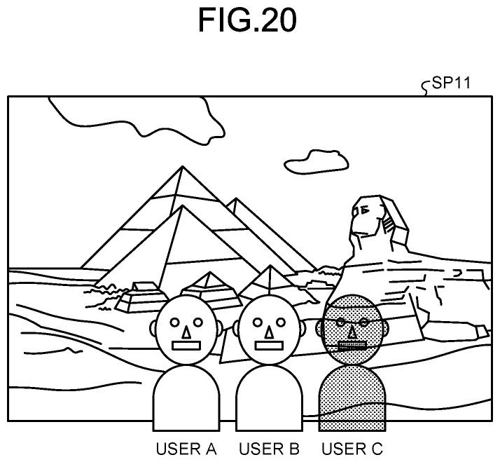

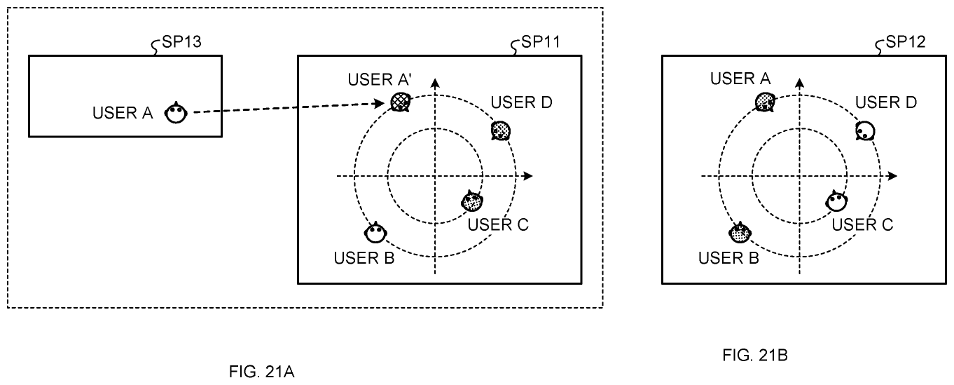

FIG. 20 is a view illustrating the tenth example of the information processing system 1 according to the embodiment. In FIG. 20, the space SP11 is a space of a tourist spot. Then, it is assumed that a user A and a user B are moving together in the space of the space SP11, for example, during a sightseeing tour. In addition, it is assumed that a user C is not in the space SP11. For example, it is assumed that the user C is in a private room. In this case, the information processing device 10 performs processing for presenting an environmental sound generated in the space of the space SP11 to the user C. For example, the information processing device 10 performs processing for presenting, to the user C, an environmental sound collected by a microphone worn by the user A or the user B or an environmental sound collected by a microphone installed in a town or the like of the tourist spot. As a result, the information processing device 10 can appropriately perform processing for presenting the environmental sound on a side of the tourist spot to a user who is not on the side of the tourist spot. Furthermore, the information processing device 10 performs processing for not presenting an environmental sound generated in the space where the user C is to the user A and the user B during communication between the user A to the user C. As a result, the information processing device 10 can appropriately perform processing for not presenting the environmental sound of the user who is not on the side tourist spot to the user on the tourist spot side. As a result, the information processing device 10 can appropriately present the environmental sound in one direction from the side of the tourist spot to the side that is not on the side of the tourist spot.

In the tenth example, the information processing device 10 may determine a position of each user in a virtual space from a positional relationship between the users with reference to any user in the tourist spot. For example, the information processing device 10 may determine a position of the user A in the virtual space from a positional relationship between the user A and the user B in a real space with the user B as a reference. Furthermore, for example, the information processing device 10 may determine a position of the user C in the virtual space from a positional relationship between the user B and the user C which relationship is determined in advance with reference to the user B. For example, the information processing device 10 may determine the position of the user C in the virtual space by previously determining the position of the user C on a left side of the user B.

In the tenth example, in a case where a space of the target user is the tourist spot, with reference to one of users in the same space as the target user, the generation unit 1122 generates output data to reproduce a sound image of a sound, which is made by the first user and is other than an environmental sound generated in a different space, at a position based on the reference in the virtual space.

### 2.4.10. Teleoperator Robot, Etc. (Eleventh Example)

In the above embodiment, a case where a participant in remote communication is a user has been described. However, this example is not a limitation. For example, in the above embodiment, a participant in the remote communication may be a robot. Here, processing of a case where one of participants in remote communication is a robot will be described. Note that an example of a case where one of the participants in the remote communication is a robot will be hereinafter referred to as an “eleventh example” as appropriate.

FIG. 21 is a view illustrating the eleventh example of the information processing system 1 according to the embodiment. In FIG. 21, a user B in a space SP11, a user C and a user D in a space SP12, and a user A in a space SP13 remotely communicate with each other. The space SP11 to the space SP13 are spaces different from each other. Here, a user A prime in the space SP11 is a robot remotely operated by the user A. For example, the user A prime is a robot that utters on the basis of operation by the user A. The user A is also a user who participates in the remote communication as a user in the space SP11 via the user A prime. In this case, the information processing device 10 performs processing for the user A to the user D to remotely communicate with each other with the user A prime as the user A. Specifically, the information processing device 10 performs processing for the user A to the user D to remotely communicate with each other with a position of the user A prime as a position of the user A and a direction of the user A prime as a direction of the user A. In such a manner, on the basis of a positional relationship between the user A prime and the user B to the user D in a virtual space, the information processing device 10 performs processing for the user A to the user D to remotely communicate with each other.

Note that the robot according to the eleventh example is not limited to a robot remotely operated by one user, and may be, for example, a robot that autonomously thinks. In this case, the information processing device 10 performs processing with the autonomously thinking robot itself as a user who participates in the remote communication. Furthermore, the robot according to the eleventh example may be, for example, a target object (object) such as a television, a speaker, or the like.

### 2.4.11. Calibration (Twelfth Example)

When a voice volume level of each user varies depending on a difference in performance of a microphone, a distance between the microphone and a mouth, or the like, presence may be impaired. Here, processing of a case of equalizing basic voice volume by performing calibration for each user in advance will be described. Note that an example of a case where calibration is performed for each user in advance will be hereinafter referred to as a “twelfth example” as appropriate.

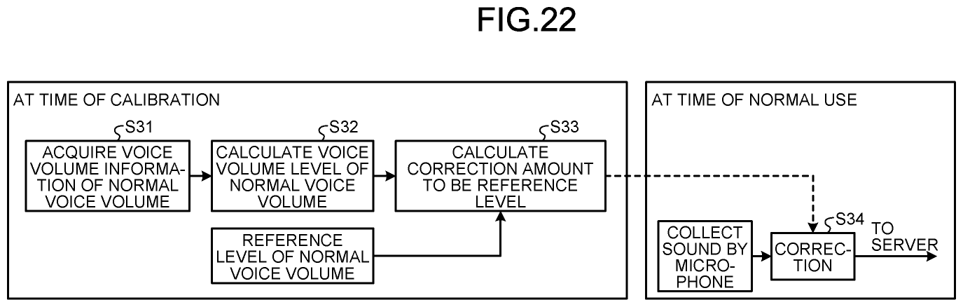

FIG. 22 is a view illustrating an example of calibration processing according to the embodiment. In the twelfth example, each user utters in normal voice volume in a state of wearing a microphone. The information processing device 10 acquires voice volume information of the normal voice volume of each user (S31). Furthermore, the information processing device 10 calculates a voice volume level of the normal voice volume on the basis of the acquired voice volume information (S32). At this time, the information processing device 10 may store the calculated voice volume level. Then, the information processing device 10 calculates a correction amount for adjusting the calculated voice volume level to be a predetermined reference level of the normal voice volume on the basis of the calculated voice volume level and the predetermined reference level of the normal voice volume (S33). For example, in a case where the voice volume level during normal utterance is −18 dB and the reference level is −6 dB, the information processing device 10 calculates the correction amount of +12 dB. The above is the processing by the information processing device 10 at the time of the calibration. Then, when the correction amount is used, the information processing device 10 acquires the voice volume information of the voice collected by the microphone and corrects the voice volume level based on the acquired voice volume information (S34).

In the twelfth example, the processing unit 112 may include a calculation unit 1124. Each of the determination unit 1121, the generation unit 1122, and the calculation unit 1124 or the determination unit 1121, the generation unit 1122, the estimation unit 1123, and the calculation unit 1124 included in the processing unit 112 may be configured as an independent computer program module, or a plurality of functions may be configured as one integrated computer program module.

The calculation unit 1124 has a function of calculating the voice volume level of the normal voice volume. In addition, the calculation unit 1124 calculates a correction amount to adjust the voice volume level to a predetermined reference level of normal voice volume.

### 3. Hardware Configuration Example

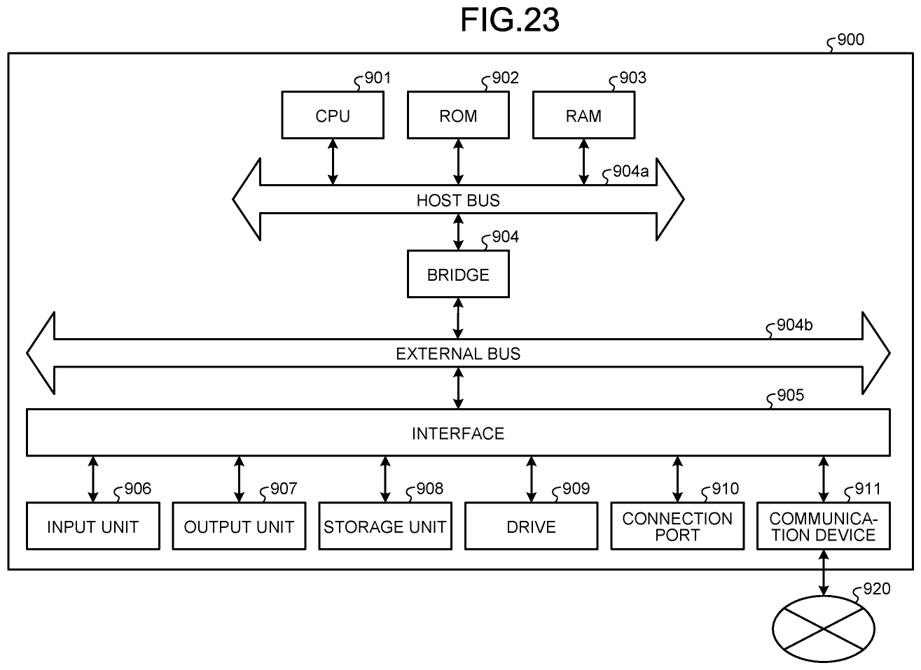

Finally, a hardware configuration example of the information processing device according to the embodiment will be described with reference to FIG. 23. FIG. 23 is a block diagram illustrating a hardware configuration example of the information processing device according to the embodiment. Note that an information processing device 900 illustrated in FIG. 23 can realize, for example, the information processing device 10 and the earphone 20 illustrated in FIG. 6. Information processing by the information processing device 10 and the earphone 20 according to the embodiment is realized by cooperation of software (including a computer program) and hardware described below.

As illustrated in FIG. 23, the information processing device 900 includes a central processing unit (CPU) 901, a read only memory (ROM) 902, and a random access memory (RAM) 903. Furthermore, the information processing device 900 includes a host bus 904a, a bridge 904, an external bus 904b, an interface 905, an input device 906, an output device 907, a storage device 908, a drive 909, a connection port 910, and a communication device 911. Note that the hardware configuration illustrated here is an example, and a part of the components may be omitted. In addition, the hardware configuration may further include components other than the components described here.

The CPU 901 functions as, for example, an arithmetic processing device or a control device, and controls overall operation or a part thereof of each component on the basis of various computer programs recorded in the ROM 902, the RAM 903, or the storage device 908. The ROM 902 is a unit that stores a program read by the CPU 901, data used for calculation, and the like. The RAM 903 temporarily or permanently stores, for example, a program read by the CPU 901 and data (part of the program) such as various parameters that appropriately change when the program is executed. These are mutually connected by the host bus 904a including a CPU bus or the like. The CPU 901, the ROM 902, and the RAM 903 can realize the functions of the control unit 110 and the control unit 210 described with reference to FIG. 6, for example, in cooperation with software.

The CPU 901, the ROM 902, and the RAM 903 are mutually connected via, for example, the host bus 904a capable of high-speed data transmission. On the other hand, the host bus 904a is connected to an external bus 904b having a relatively low data transmission speed via the bridge 904, for example. Furthermore, the external bus 904b is connected to various components via the interface 905.

The input device 906 is realized by, for example, a device to which information is input by a listener, such as a mouse, a keyboard, a touch panel, a button, a microphone, a switch, and a lever. Furthermore, the input device 906 may be, for example, a remote control device using infrared rays or other radio waves, or may be external connection equipment such as a mobile phone or a PDA corresponding to the operation of the information processing device 900. Furthermore, the input device 906 may include, for example, an input control circuit or the like that generates an input signal on the basis of the information input by utilization of the above input units, and that performs an output thereof to the CPU 901. By operating the input device 906, an administrator of the information processing device 900 can input various kinds of data to or can give an instruction for processing operation to the information processing device 900.

In addition, the input device 906 may include a device that detects a position of a user. For example, the input device 906 may include various sensors such as an image sensor (such as a camera), a depth sensor (such as stereo camera), an acceleration sensor, a gyroscope sensor, a geomagnetic sensor, an optical sensor, a sound sensor, a ranging sensor (such as a time of flight (ToF) sensor), and a force sensor. Furthermore, the input device 906 may acquire information related to a state of the information processing device 900 itself, such as a posture and moving speed of the information processing device 900, and information related to a surrounding space of the information processing device 900, such as brightness and din around the information processing device 900. Furthermore, the input device 906 may include a global navigation satellite system (GNSS) module that receives a GNSS signal from a GNSS satellite (such as a global positioning system (GPS) signal from a GPS satellite) and that measures positional information including latitude, longitude, and altitude of the device. Furthermore, with respect to positional information, the input device 906 may detect a position by transmission and reception with Wi-Fi (registered trademark), a mobile phone, a PHS, a smartphone, or the like, or near field communication, for example. The input device 906 can realize, for example, the function of the acquisition unit 111 described with reference to FIG. 6.

The output device 907 includes a device capable of visually or aurally notifying the user of the acquired information. Examples of such a device include a display device such as a CRT display device, a liquid crystal display device, a plasma display device, an EL display device, a laser projector, an LED projector, and a lamp, a sound output device such as a speaker and a headphone, and a printer device. The output device 907 outputs, for example, results acquired by various kinds of processing performed by the information processing device 900. Specifically, the display device visually displays the results, which are acquired by the various kinds of processing performed by the information processing device 900, in various formats such as text, an image, a table, and a graph. On the other hand, the audio output device converts an audio signal including reproduced voice data, acoustic data, or the like into an analog signal and performs an aural output thereof. The output device 907 can realize, for example, the functions of the output unit 113 and the output unit 220 described with reference to FIG. 6.

The storage device 908 is a device that is for data storage and that is formed as an example of a storage unit of the information processing device 900. The storage device 908 is realized, for example, by a magnetic storage unit device such as an HDD, a semiconductor storage device, an optical storage device, a magneto-optical storage device, or the like. The storage device 908 may include a storage medium, a recording device that records data into the storage medium, a reading device that reads the data from the storage medium, a deletion device that deletes the data recorded in the storage medium, and the like. The storage device 908 stores computer programs executed by the CPU 901, various kinds of data, various kinds of data acquired from the outside, and the like. The storage device 908 can realize, for example, the function of the storage unit 120 described with reference to FIG. 6.

The drive 909 is a reader/writer for a storage medium, and is built in or externally attached to the information processing device 900. The drive 909 reads information recorded in a mounted removable storage medium such as a magnetic disk, optical disk, magneto-optical disk, or semiconductor memory, and performs an output thereof to the RAM 903. Also, the drive 909 can write information into the removable storage medium.

The connection port 910 is, for example, a port for connecting external connection equipment such as a universal serial bus (USB) port, an IEEE 1394 port, a small computer system interface (SCSI), an RS-232C port, or an optical audio terminal.

The communication device 911 is, for example, a communication interface formed of a communication device or the like for connection to a network 920. The communication device 911 is, for example, a communication card for a wired or wireless local area network (LAN), long term evolution (LTE), Bluetooth (registered trademark), or a wireless USB (WUSB), or the like. Also, the communication device 911 may be a router for optical communication, a router for an asymmetric digital subscriber line (ADSL), a modem for various kinds of communication, or the like. On the basis of a predetermined protocol such as TCP/IP, the communication device 911 can transmit/receive a signal or the like to/from the Internet or another communication equipment, for example. The communication device 911 can realize, for example, the functions of the communication unit 100 and the communication unit 200 described with reference to FIG. 6.

Note that the network 920 is a wired or wireless transmission path of information transmitted from a device connected to the network 920. For example, the network 920 may include a public network such as the Internet, a telephone network, or a satellite communication network, various local area networks (LAN), a wide area network (WAN), and the like including Ethernet (registered trademark). Also, the network 920 may include a dedicated network such as the Internet protocol-virtual private network (IP-VPN).

An example of the hardware configuration capable of realizing the functions of the information processing device 900 according to the embodiment has been described above. Each of the above-described components may be realized by utilization of a general-purpose member, or may be realized by hardware specialized for the function of each component. Thus, it is possible to appropriately change the hardware configuration to be used according to a technical level at the time of carrying out the embodiment.

### 4. Conclusion

As described above, the information processing device 10 according to the embodiment generates output data to reproduce a sound image of a sound, which is generated in a different space different from the space of the target user, in the space of the target user. Furthermore, the information processing device 10 generates the output data by using a sound other than a sound that can be directly heard by the target user. As a result, the information processing device 10 can present only necessary sound by virtual processing, whereby it is possible to promote improvement in presence. As a result, the information processing device 10 can promote reduction in processing resources. In addition, the information processing device 10 generates output data to the target user on the basis of a head-related transfer function of the target user which function is based on a sound generation position in a different space. As a result, since the information processing device 10 can localize a sound image at an intended position, it is possible to promote improvement in sound quality of when a sound image is reproduced. Furthermore, the information processing device 10 generates output data to the target user on the basis of a positional relationship between the first user and the target user in the virtual space. As a result, the information processing device 10 can promote improvement of presence as if the target user exists in the same space as the first user.

Thus, it is possible to provide a new and improved information processing device, information processing method, and information processing system capable of promoting further improvement in usability.

A preferred embodiment of the present disclosure has been described in detail in the above with reference to the accompanying drawings. However, the technical scope of the present disclosure is not limited to such an example. It is obvious that a person having ordinary knowledge in the technical field of the present disclosure can conceive various alterations or modifications within the scope of the technical idea described in the claims, and it should be understood that these alterations or modifications naturally belong to the technical scope of the present disclosure.

For example, each device described in the present specification may be realized as a single device, or some or all of the devices may be realized as separate devices. For example, the information processing device 10 and the earphone 20 illustrated in FIG. 6 may be realized as independent devices. Furthermore, for example, realization as a server device connected to the information processing device 10 and the earphone 20 via a network or the like is possible. Furthermore, the function of the control unit 110 included in the information processing device 10 may be included in the server device connected via the network or the like.

Furthermore, the series of processing by each device described in the present specification may be realized using any of software, hardware, or a combination of software and hardware. The computer program included in the software is stored in advance in, for example, a recording medium (non-transitory medium) provided inside or outside each device. Then, each program is read into the RAM, for example, at the time of execution by a computer and is executed by a processor such as a CPU.

Furthermore, the processing described by utilization of the flowchart in the present specification may not necessarily be executed in the illustrated order. Some processing steps may be performed in parallel. In addition, an additional processing step may be employed, and some processing steps may be omitted.

In addition, the effects described in the present specification are merely illustrative or exemplary, and are not restrictive. That is, in addition to the above effects or instead of the above effects, the technology according to the present disclosure can exhibit a different effect obvious to those skilled in the art from the description of the present specification.

Note that the following configurations also belong to the technical scope of the present disclosure.

(1)

An information processing device including:
an acquisition unit that acquires a positional relationship between a plurality of users arranged in a virtual space; and
a generation unit that generates, on a basis of the positional relationship acquired by the acquisition unit, output data of a sound to be presented to a target user from sound data of a sound made by each of the users, wherein
the generation unit generates the output data by using a sound other than a sound that can be directly heard by the target user among the sounds respectively made by the users.
   (2)

The information processing device according to (1), wherein
the generation unit
generates, in order to reproduce a sound image of a sound made by a first user who is in a different space, the output data to the target user on a basis of a head-related transfer function of the target user which function is based on a positional relationship in a virtual space between the first user and the target user of when the sound is generated.
   (3)

The information processing device according to (2), wherein
the generation unit
generates, as the positional relationship, the output data to the target user on a basis of the head-related transfer function of the target user which function is based on a relative position or a relative direction.
   (4)

The information processing device according to (2) or (3), wherein
the generation unit
generates the output data to the target user by combining the sound data of users in the different space which sound data is generated on a basis of voice information of each of the users and the head-related transfer function of the target user.
   (5)

The information processing device according to any one of (2) to (4), wherein
the generation unit
generates the output data to the target user on a basis of the positional relationship based on positional information of the target user, which positional information is based on a coordinate system determined in a space of the target user, and positional information of the first user which positional information is based on a coordinate system determined in the different space.
   (6)

The information processing device according to any one of (2) to (5), further including
a determination unit that determines, on a basis of whether the target user is in a range in which a sound emitted by the first user can be directly heard, that the first user is in the different space in a case where the target user is not in the range.
   (7)

The information processing device according to any one of (2) to (6), wherein
the generation unit
generates the output data to the target user on a basis of the head-related transfer function of the target user which function includes reflection and reverberation of a sound generated in the different space until the sound reaches the target user in the virtual space on a basis of the positional relationship between the first user and the target user in the virtual space, positional information of the first user in the virtual space, and positional information of the target user in the virtual space.
   (8)

The information processing device according to any one of (2) to (7), wherein
the generation unit
generates, in a case where a difference between a degree of reflection and reverberation of a sound which degree is estimated on a basis of attribute information of a space of the target user and a degree of reflection and reverberation of a sound which degree is estimated on a basis of attribute information of the different space is equal to or larger than a predetermined threshold, the output data to the target user by using the degree of reflection and reverberation of the sound, which degree is estimated on a basis of the attribute information of the space of the target user, for reflection and reverberation of the sound in the virtual space.
   (9)

The information processing device according to any one of (2) to (8), wherein
the generation unit
generates, in order to reproduce only a sound image of a sound intended by the user in the different space, the output data to the target user which output data is to reproduce only a sound image of a sound in an utterance section of the first user among utterance sections detected by utterance section detection or sound discrimination.
   (10)

The information processing device according to any one of (2) to (9), wherein
the generation unit
generates, in order to reproduce only a sound image of a sound intended by the user in the different space, the output data to the target user which output data is to reproduce only a sound image of a sound of the first user which sound is collected by utilization of beam forming processing by a directional microphone or an array microphone.
   (11)

The information processing device according to any one of (2) to (10), wherein
the generation unit
generates, in order to reproduce only a sound image of a sound intended by the user in the different space, the output data to the target user by canceling a sound made by a second user who is in a same space as the first user among sounds collected by a microphone of the first user who is in the different space.
   (12)

The information processing device according to any one of (2) to (11), wherein
the generation unit
generates, in a case of reproducing only a sound image of a sound of the first user which sound is collected by utilization of a microphone installed in the different space, the output data to the target user by using beam forming processing targeting a position of the first user from the microphone on a basis of positional information of the microphone in a space of the different space and positional information of the first user in the space of the different space.
   (13)

The information processing device according to any one of (2) to (12), wherein
the generation unit
generates output data to the target user which output data is to reproduce a sound image of an environmental sound other than a sound made by each user in the different space.
   (14)

The information processing device according to any one of (2) to (13), further including
an estimation unit that estimates a generation position of a sound generated in the different space, wherein
the generation unit
generates the output data to the target user which output data is to reproduce a sound image of the sound, which is generated in the different space, in the virtual space on a basis of the generation position estimated by the estimation unit.
   (15)

The information processing device according to any one of (2) to (14), wherein
the generation unit
generates the output data to the target user which output data is to reproduce, at a predetermined position in the virtual space which position is estimated on a basis of attribute information of an environmental sound generated in the different space and attribute information of a space of the target user, a sound image of the environmental sound.
   (16)

The information processing device according to any one of (2) to (15), wherein
the generation unit
generates, in a case where the first user makes a sound with a volume equal to or smaller than a predetermined threshold, the output data to the target user specified on a basis of eye gaze information of the first user, and output data to the second user who is in a same space as the first user which output data is to cancel the sound made by the first user in such a manner that the second user does not hear the sound made by the first user.
   (17)

The information processing device according to any one of (2) to (16), wherein
the generation unit
generates, in a case where number of users in the different space is equal to or larger than a predetermined threshold, the output data to the target user with a plurality of sounds made by the users of the number being one sound source, the output data being to reproduce a sound image of the sound source at a predetermined position in the virtual space.
   (18)

The information processing device according to any one of (2) to (17), wherein
the generation unit
generates, in a case where a space of the target user has predetermined attribute information, the output data to the target user with any user in a same space as the target user being a reference, the output data being to reproduce, at a position based on the reference in the virtual space, the sound image of the sound made by the first user other than an environmental sound generated in the different space.
   (19)

The information processing device according to any one of (1) to (18), wherein
the generation unit
generates the output data by using a sound other than a sound generated in a real space of the target user as a sound that can be directly heard by the target user.
   (20)

An information processing method executed by a computer,
the information processing method including:
an acquisition step of acquiring a positional relationship between a plurality of users arranged in a virtual space; and
a generation step of generating, on a basis of the positional relationship acquired in the acquisition step, output data of a sound to be presented to a target user from sound data of a sound made by each of the users, wherein
in the generation step, the output data is generated by utilization of a sound other than a sound that can be directly heard by the target user among the sounds respectively made by the users.
   (21)

An information processing system including:
an information processing device that provides output data of a sound to be presented to a target user from sound data of a sound made by each of a plurality of users arranged in a virtual space, the output data using a sound other than a sound that can be directly heard by the target user and being generated on a basis of a positional relationship between the plurality of users; and
a reproduction device that reproduces the output data provided from the information processing device.

### REFERENCE SIGNS LIST

N INFORMATION COMMUNICATION NETWORK
1 INFORMATION PROCESSING SYSTEM
10 INFORMATION PROCESSING DEVICE
20 EARPHONE
100 COMMUNICATION UNIT
110 CONTROL UNIT
111 ACQUISITION UNIT
112 PROCESSING UNIT
1121 DETERMINATION UNIT
1122 GENERATION UNIT
1123 ESTIMATION UNIT
1124 CALCULATION UNIT
113 OUTPUT UNIT
200 COMMUNICATION UNIT
210 CONTROL UNIT
220 OUTPUT UNIT

1. An information processing device including:
an acquisition unit that acquires a positional relationship between a plurality of users arranged in a virtual space; and
a generation unit that generates, on a basis of the positional relationship acquired by the acquisition unit, output data of a sound to be presented to a target user from sound data of a sound made by each of the users, wherein
the generation unit generates the output data by using a sound other than a sound that can be directly heard by the target user among the sounds respectively made by the users.

2. The information processing device according to claim 1, wherein
the generation unit
generates, in order to reproduce a sound image of a sound made by a first user who is in a different space, the output data to the target user on a basis of a head-related transfer function of the target user which function is based on a positional relationship in a virtual space between the first user and the target user of when the sound is generated.

3. The information processing device according to claim 2, wherein
the generation unit
generates, as the positional relationship, the output data to the target user on a basis of the head-related transfer function of the target user which function is based on a relative position or a relative direction.

4. The information processing device according to claim 2, wherein
the generation unit
generates the output data to the target user by combining the sound data of users in the different space which sound data is generated on a basis of voice information of each of the users and the head-related transfer function of the target user.

5. The information processing device according to claim 2, wherein
the generation unit
generates the output data to the target user on a basis of the positional relationship based on positional information of the target user, which positional information is based on a coordinate system determined in a space of the target user, and positional information of the first user which positional information is based on a coordinate system determined in the different space.

6. The information processing device according to claim 2, further including
a determination unit that determines, on a basis of whether the target user is in a range in which a sound emitted by the first user can be directly heard, that the first user is in the different space in a case where the target user is not in the range.

7. The information processing device according to claim 2, wherein
the generation unit
generates the output data to the target user on a basis of the head-related transfer function of the target user which function includes reflection and reverberation of a sound generated in the different space until the sound reaches the target user in the virtual space on a basis of the positional relationship between the first user and the target user in the virtual space, positional information of the first user in the virtual space, and positional information of the target user in the virtual space.

8. The information processing device according to claim 2, wherein
the generation unit
generates, in a case where a difference between a degree of reflection and reverberation of a sound which degree is estimated on a basis of attribute information of a space of the target user and a degree of reflection and reverberation of a sound which degree is estimated on a basis of attribute information of the different space is equal to or larger than a predetermined threshold, the output data to the target user by using the degree of reflection and reverberation of the sound, which degree is estimated on a basis of the attribute information of the space of the target user, for reflection and reverberation of the sound in the virtual space.

9. The information processing device according to claim 2, wherein
the generation unit
generates, in order to reproduce only a sound image of a sound intended by the user in the different space, the output data to the target user which output data is to reproduce only a sound image of a sound in an utterance section of the first user among utterance sections detected by utterance section detection or sound discrimination.

10. The information processing device according to claim 2, wherein
the generation unit
generates, in order to reproduce only a sound image of a sound intended by the user in the different space, the output data to the target user which output data is to reproduce only a sound image of a sound of the first user which sound is collected by utilization of beam forming processing by a directional microphone or an array microphone.

11. The information processing device according to claim 2, wherein
the generation unit
generates, in order to reproduce only a sound image of a sound intended by the user in the different space, the output data to the target user by canceling a sound made by a second user who is in a same space as the first user among sounds collected by a microphone of the first user who is in the different space.

12. The information processing device according to claim 2, wherein
the generation unit
generates, in a case of reproducing only a sound image of a sound of the first user which sound is collected by utilization of a microphone installed in the different space, the output data to the target user by using beam forming processing targeting a position of the first user from the microphone on a basis of positional information of the microphone in a space of the different space and positional information of the first user in the space of the different space.

13. The information processing device according to claim 2, wherein
the generation unit
generates output data to the target user which output data is to reproduce a sound image of an environmental sound other than a sound made by each user in the different space.

14. The information processing device according to claim 2, further including
an estimation unit that estimates a generation position of a sound generated in the different space, wherein
the generation unit
generates the output data to the target user which output data is to reproduce a sound image of the sound, which is generated in the different space, in the virtual space on a basis of the generation position estimated by the estimation unit.

15. The information processing device according to claim 2, wherein
the generation unit
generates the output data to the target user which output data is to reproduce, at a predetermined position in the virtual space which position is estimated on a basis of attribute information of an environmental sound generated in the different space and attribute information of a space of the target user, a sound image of the environmental sound.

16. The information processing device according to claim 2, wherein
the generation unit
generates, in a case where the first user makes a sound with a volume equal to or smaller than a predetermined threshold, the output data to the target user specified on a basis of eye gaze information of the first user, and output data to the second user who is in a same space as the first user which output data is to cancel the sound made by the first user in such a manner that the second user does not hear the sound made by the first user.

17. The information processing device according to claim 2, wherein
the generation unit
generates, in a case where number of users in the different space is equal to or larger than a predetermined threshold, the output data to the target user with a plurality of sounds made by the users of the number being one sound source, the output data being to reproduce a sound image of the sound source at a predetermined position in the virtual space.

18. The information processing device according to claim 2, wherein
the generation unit
generates, in a case where a space of the target user has predetermined attribute information, the output data to the target user with any user in a same space as the target user being a reference, the output data being to reproduce, at a position based on the reference in the virtual space, the sound image of the sound made by the first user other than an environmental sound generated in the different space.

19. The information processing device according to claim 1, wherein
the generation unit
generates the output data by using a sound other than a sound generated in a real space of the target user as a sound that can be directly heard by the target user.

20. An information processing method executed by a computer,
the information processing method including:
an acquisition step of acquiring a positional relationship between a plurality of users arranged in a virtual space; and
a generation step of generating, on a basis of the positional relationship acquired in the acquisition step, output data of a sound to be presented to a target user from sound data of a sound made by each of the users, wherein
in the generation step, the output data is generated by utilization of a sound other than a sound that can be directly heard by the target user among the sounds respectively made by the users.

21. An information processing system including:
an information processing device that provides output data of a sound to be presented to a target user from sound data of a sound made by each of a plurality of users arranged in a virtual space, the output data using a sound other than a sound that can be directly heard by the target user and being generated on a basis of a positional relationship between the plurality of users; and
a reproduction device that reproduces the output data provided from the information processing device.
